(19) United States
(12) Patent Application Publication
(10) Pub. No.: US 2006/0226777 A1
(43) Pub. Date: Oct. 12, 2006

(54) Incandescent lamp incorporating extended high-reflectivity IR coating and lighting fixture incorporating such an incandescent lamp

(76) Inventor: David W. Cunningham, Los Angeles, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/388,770

(22) Filed: Mar. 24, 2006

Related U.S. Application Data
(60) Provisional application No. 60/669,597, filed on Apr. 7, 2005.

(51) Int. Cl. H01K 1/00

(52) U.S. Cl. 313/580

(57) ABSTRACT

An incandescent lamp is disclosed, incorporating a special optical coating system that enables the lamp to provide an improved luminous efficacy. In one form, the optical coating system includes a plurality of dielectric layers having prescribed refractive indices and prescribed thicknesses, which are selected such that the optical coating provides a prescribed transmittance/reflectance spectrum having an average reflectance greater than 90% across an infrared wavelength range of 740 to 2000 nm and further having an average transmittance of less than 90% across a visible wavelength range of 400 to 700 nm. In another form, the optical coating system includes two distinct coatings: (1) a first coating including a plurality of dielectric layers having prescribed refractive indices and prescribed thicknesses, which are selected such that the first coating provides a prescribed transmittance/reflectance spectrum, and (2) a second coating including a transparent electrically conductive material configured such that the second coating provides a prescribed transmittance/reflectance spectrum. The invention also is embodied in a lighting fixture incorporating an optical coating as described above, located either on the envelope of the incandescent lamp, itself, or on another substrate of the fixture, separate and apart from the lamp, e.g., a fixed transparent envelope surrounding the incandescent lamp.

### CROSS-REFERENCE TO RELATED APPLICATION

Priority is claimed under 35 U.S.C. § 119(e) to the U.S. Provisional Patent Application No. 60/669,597, filed on Apr. 7, 2005, entitled “Incandescent Lamp Incorporating Extended High-Reflectivity IR Coating,” by David W. Cunningham, which application is incorporated by reference herein.

### BACKGROUND OF THE INVENTION

This invention relates generally to incandescent lamps and, more particularly, to incandescent lamps having transparent envelopes that carry infrared (IR)-reflective coatings. The invention also relates to lighting fixtures incorporating such incandescent lamps.

Incandescent lamps having transparent envelopes that carry IR-reflective coatings, typically in the form of multi-layer stacks of dielectric materials, are well known in the lighting industry. Such dielectric coatings include alternating layers of high-refractive index materials, e.g., niobia (Nb₂O₅), tantala (Ta₂O₅), and titania (TiO₂), and low-refractive index materials, e.g., silica (SiO₂), wherein the layer thicknesses are controlled to be substantially one quarter the wavelength of the light to be reflected by constructive interference. The successive layers of such coatings are typically created using physical vapor deposition (PVD), reactive sputtering, low-pressure chemical vapor deposition (LP-CVD), or plasma-enhanced chemical vapor deposition (PE-CVD) to deposit various oxides onto a substrate, such as glass.

Multi-layer dielectric coatings can be designed to be highly reflective in a range of wavelengths and highly transmissive in other wavelengths. For example, a dielectric coating that reflects IR light, usually in the range of 750 to 1600 nanometers (nm), but transmits other wavelengths of light, is commonly called a “hot mirror,” a “low-wavelength pass edge-filter,” or an “IR coating.” The transition from reflecting wavelengths to transmitting wavelengths can be made very narrow, typically around 50 nm or less.

IR coatings were first combined with quartz-halogen lamps in the late-1980s to increase an incandescent lamp's luminous efficacy. Incandescent light sources typically produce about 10-15% visible light and about 85-90% IR light. An IR coating on an incandescent lamp's transparent envelope reflects a substantial portion of the IR light emitted by the lamp filament back onto the filament. The filament absorbs a portion of that IR light, thereby reducing the amount of electrical power required to heat the filament to a given temperature and consequently increasing the lamp's luminous efficacy. Lamps incorporating linear filaments, e.g., GE's FCM/HIR lamp, exhibit improved luminous efficacy as high as 40% (from 28 lumens per watt (LPW) for an uncoated lamp to 39 LPW for a coated lamp). The IR coatings currently employed in the lighting industry by companies such as GE, Osram Sylvania, Philips Lighting, and Deposition Sciences have a spectral transmittance similar to the graph shown in FIG. 1.

IR-coated quartz halogen lamps generally are available in two form factors: “linear lamps” and “elliptical lamps.” Linear lamps generally have a long, single-coiled filament and a concentric tubular envelope. Most of the IR light reflected by the coating is redirected back to the filament, because the filament is a cylindrical object concentric with the cylindrical IR-coated envelope. A typical linear IR lamp is GE's FCM/HIR, shown in FIG. 2. Elliptical lamps generally have a short, coiled-coil filament and an elliptical envelope. The IR-coated elliptical reflector is configured with its two foci located approximately at the ends of the filament. For this reason, most of the IR light reflected by the coating is redirected back to the filament, and large end losses associated with short filaments are avoided. A typical IR elliptical lamp is GE's 90 PAR/HIR, shown in FIG. 3.

Transparent conductive coatings (TCCs), formed of materials such as indium tin oxide (ITO), have been widely used in products where it is desirable to make a non-conducting substrate, such as glass, electrically conductive yet highly transmissive to visible light. By appropriately varying the doping and thickness of the TCC and by controlling the deposition process, a coating can be made to have a visible light transmissivity greater than 85% and to be electrically conductive (e.g., ˜20 Ω/square). Such a coating also has the property of having a reflectivity to IR light that increases gradually at longer wavelengths. In one example, depicted in FIG. 4, a typical 200-nm thick ITO coating is about 8% reflective at 1000 nm, 45% reflective at 2000 nm, and 72% reflective at 3000 nm. The wavelength at which transmittance and reflectance of this coating are equal, also known as the “plasma frequency,” is approximately 1.850 nm.

As shown in FIG. 1, IR coatings used in the past with quartz-halogen lamps generally transmit on the order of 5 to 30% of IR light in a wavelength range of 740 to 1600 nm, 20 to 90% of IR light in a wavelength range of 1600 to 2200 nm, and greater than 75% of IR light at wavelengths above 2200 nm. Because dielectric coatings have very little absorption at these wavelengths, and because light is either reflected, transmitted or absorbed, it follows that the prior art IR coating shown in FIG. 1 reflects 70 to 95% of IR light in the range of 750 to 1600 nm, 10 to 80% of IR light in the range of 1600 to 2200 nm, and less than 20% of IR light above 2200 nm. Peak IR emittance from a typical tungsten filament operating at 3000K (color temperature) is known to occur at about 980 nm, and more than half of the IR power from such a filament is located in a wavelength range of 750 to 1600 nm. Consequently, prior art coating designs generally have been thought to be highly effective at redirecting most of the IR light back to the lamp filament.

Another prior art IR coating design, which is disclosed in U.S. Pat. No. 6,476,556 to E. Cottaar, includes an interference film having a transmittance that averages at least 90% in the visible wavelength range of 400 to 760 nm and having a reflectance that averages at least 75% in the infrared wavelength range of 800 to 2200 nm. Preferably, the interference film has a reflectance that averages at least 85% in the infrared wavelength range of 800 to 2500 nm.

In general, prior art IR coatings for quartz halogen lamps are designed to reflect the maximum integrated IR power generated by the light source. In other words, the coatings have been designed to maximize the integrated sum of reflection at each wavelength above 700 nm multiplied by the radiated power of the filament at the same wavelength. Designers of such prior art IR coatings also have sought to maintain maximum visible transmission, usually at values greater than about 90%.

The IR coating designs described briefly above have proven to be effective in improving the luminous efficacies of incandescent lamps. However, there remains a continuing need for an improved incandescent lamp, and for a lighting fixture incorporating such a lamp, exhibiting yet a higher luminous efficacy. The present invention fulfills this need and provides further related advantages.

### SUMMARY OF THE INVENTION

The present invention is embodied in an incandescent lamp incorporating an improved IR coating, as well as a lighting fixture incorporating such an IR coating, either in the lamp itself or elsewhere, providing a higher luminous efficacy than that which had previously been achieved.

In one form of the invention, an incandescent lamp includes a filament, a transparent envelope defining an enclosed space in which the filament is located, and an optical coating disposed on a surface of the envelope, for transmitting light emitted by the filament in a prescribed visible wavelength band, while reflecting back toward the filament light emitted by the filament in other wavelength bands, whereupon a portion of such reflected light is absorbed by the filament. The optical coating includes a plurality of dielectric layers having prescribed refractive indices and prescribed thicknesses, which are selected such that the optical coating provides a prescribed transmittance/reflectance spectrum having an average reflectance greater than 90% across an infrared wavelength range of 740 to 2000 nm and further having an average transmittance of less than 90% across a visible wavelength range of 400 to 700 nm. The optical coating cooperates with the filament such that the lamp provides a higher luminous efficacy than would a corresponding lamp lacking such an optical coating.

In other, more detailed features of this form of the invention, the optical coating is located on the outer surface of the transparent envelope. In addition, the refractive indices and thicknesses of the dielectric layers of the optical coating are selected such that the optical coating provides a transmittance/reflectance spectrum having an average reflectance greater than 95% across an infrared wavelength range of 740 to 2000 nm. The optical coating can include a stack of alternating layers of high- and low-refractive index materials, with the high-refractive index layers all incorporating a material selected from the group consisting of TiO₂, Ta₂O₅, NbO₂, and mixtures thereof, and with the low-refractive index layers all incorporating a material selected from the group consisting of SiO₂, Al₂O₃, and mixtures thereof.

In still other, more detailed features of the invention, the optical coating further includes one or more transparent conductive layers, which can be contiguous with the plurality of dielectric layers. These one or more transparent conductive layers are configured to have an average reflectance greater than 70% across an infrared wavelength range of 2000 to 4000 nm. The incandescent lamp can further include an electrical connector to which the transparent envelope is secured, and a reflective coating disposed on a portion of the transparent envelope adjacent to the electrical connector, for reflecting visible and infrared light back toward the filament. The optical coating is configured such that the lamp has a luminous efficacy of preferably at least 40 lumens per watt, more preferably at least 60 lumens per watt, and most preferably at least 80 lumens per watt.

In a separate and independent form of the invention, an incandescent lamp includes a filament, a transparent envelope defining an enclosed space in which the filament is located, and an optical coating system disposed on a surface of the envelope that includes two distinct coatings: (1) a first coating including a plurality of dielectric layers having prescribed refractive indices and prescribed thicknesses, which are selected such that the first coating provides a prescribed transmittance/reflectance spectrum, and (2) a second coating including a transparent conductive material having a thickness selected such that the second coating provides a prescribed transmittance/reflectance spectrum. The first and second coatings cooperate with each other and with the filament such that the lamp provides a higher luminous efficacy than would a corresponding lamp lacking such an optical coating system on its envelope.

In other, more detailed features of the invention, the optical coating's first and second coatings are contiguous with each other and located on the outer surface of the transparent envelope. In one form the second coating is located on the side of the first coating opposite the filament, while in an alternative form, the second coating is located at an intermediate location within the plurality of layers of the first coating, closer to the side of the first coating opposite the filament than to the side of the first coating facing the filament.

In yet other, more detailed features of the invention, the first coating includes a stack of alternating layers of high- and low-refractive index materials, with the high-refractive index layers all incorporating a material selected from the group consisting of TiO₂, Ta₂₀₅, NbO₂, and mixtures thereof, and with the low-refractive index layers all incorporating a material selected from the group consisting of SiO₂, Al₂O₃, and mixtures thereof. The first coating is configured such that it has an average reflectance greater than 90% across an infrared wavelength range of 740 to 2000 nm and such that it has an average transmittance less than 90% across a visible wavelength range of 400 to 700 nm.

In addition, the second coating can include a transparent conductive material selected from the group consisting of indium tin oxide, aluminum-doped zinc oxide, titanium-doped indium oxide, cadmium stannate, tin oxide-zinc stannate, gallium-doped zinc oxide, gold, silver, and mixtures thereof. The second coating is configured such that it has an average reflectance across an infrared wavelength range of 2000 to 4000 nm of preferably greater than 70%, more preferably greater than 80%, and most preferably greater than 90%. The second coating also is configured such that it has an average absorptance in the visible wavelength range of 400 to 700 nm of preferably less than 20%, more preferably less than 10%, and most preferably less than 5%.

The incandescent lamp can further include an electrical connector to which the transparent envelope is secured, and a reflective coating disposed on a portion of the transparent envelope adjacent to the electrical connector, for reflecting visible and infrared light back toward the filament. The optical coating is configured such that the lamp has a luminous efficacy of preferably at least 40 lumens per watt, more preferably at least 60 lumens per watt, and most preferably at least 80 lumens per watt.

The present invention also is embodied in a lighting fixture incorporating a housing and a lamp socket carried by the housing, and further incorporating an incandescent lamp having a form like one of those described above. Further, the present invention can be embodied in a lighting fixture incorporating an optical coating as described above, located either on the envelope of the incandescent lamp, itself, or on another substrate of the fixture, separate and apart from the lamp, e.g., a fixed transparent envelope surrounding the incandescent lamp.

Other features and advantages of the present invention should become apparent from the following description of the preferred embodiments, taken in conjunction with the accompanying drawings, which illustrate, by way of example, the principles of the invention.

### BRIEF DESCRIPTION OF THE DRAWINGS

FIG. 1 is a graph depicting the transmittance of a typical prior art incandescent lamp incorporating an IR coating, over a wavelength range of 400 to 4000 nm.

FIG. 2 is a side view of a prior art 650-watt incandescent lamp incorporating an IR coating, manufactured by GE and sold under the designation FCM/HIR.

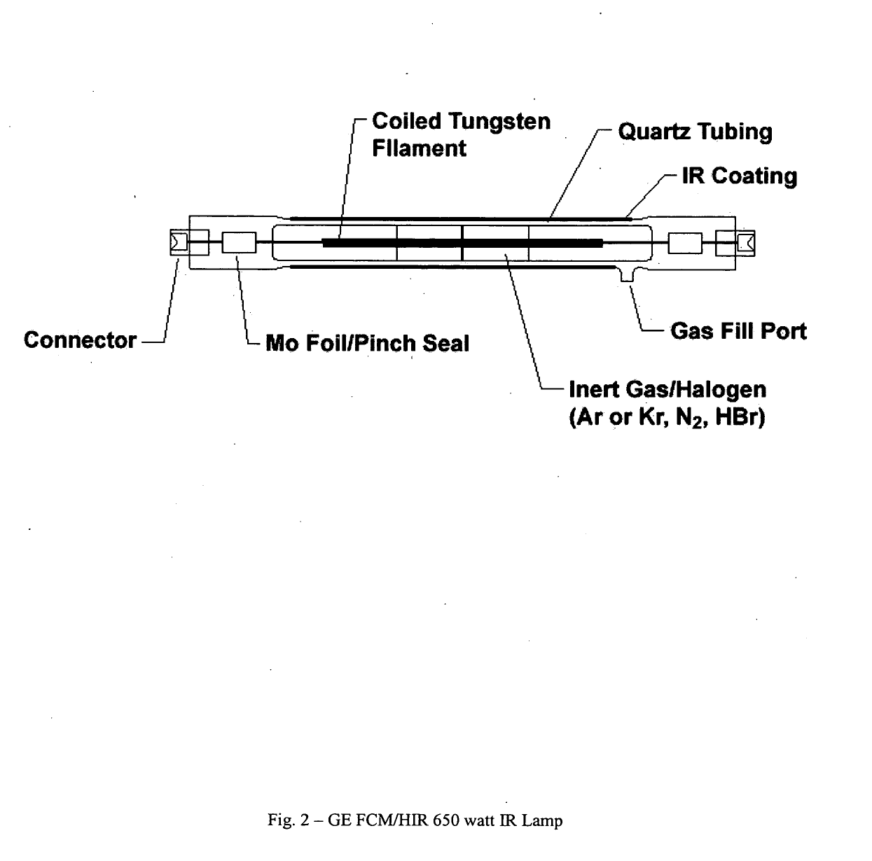

FIG. 3 is a side view of a prior art incandescent lamp incorporating an elliptical envelope that carries an IR coating, the lamp manufactured by GE and sold under the designation 90 PAR/HIR.

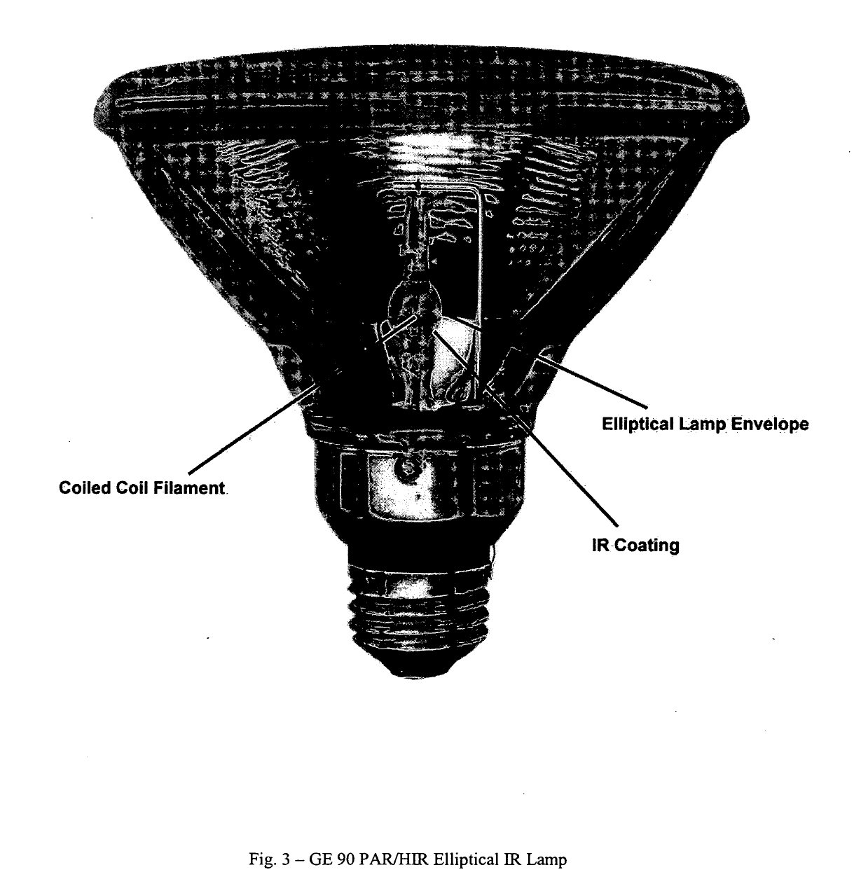

FIG. 4 is a graph depicting the transmittance, reflectance, and absorptance of a prior art transparent conductive coating incorporating indium tin oxide (ITO) and having a thickness of 200 nm.

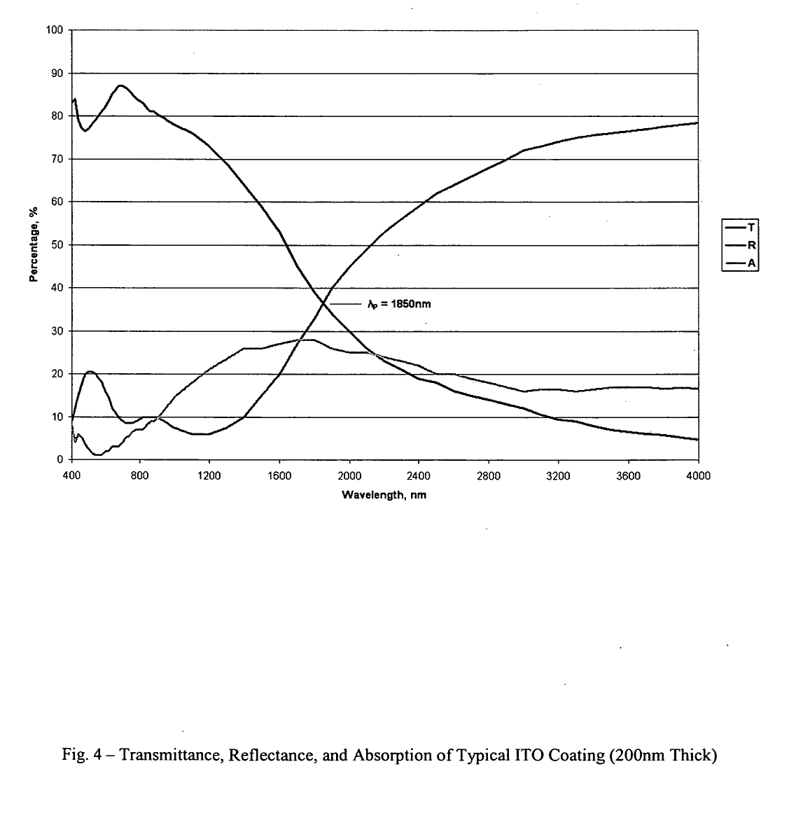

FIG. 5 is a side sectional view of a lighting fixture incorporating an incandescent lamp in accordance with the invention, like the lamp depicted in FIGS. 6A, 6B, and 6C.

FIGS. 6A, 6B, and 6C are three views depicting an incandescent lamp in accordance with the invention, incorporating an IR coating on the external surface of its transparent envelope.

FIG. 7 is a graph depicting the emissivity of tungsten at 3000K.

FIG. 8 is a graph depicting the reflectance of tungsten at 3000K.

FIG. 9 is a schematic diagram useful in describing the transmission, reflection, and absorption of light in an incandescent lamp incorporating an IR coating.

FIG. 10 is a graph depicting an IR-coated incandescent lamp's system transmittance as a function of the transmittance of the lamp's coating, at wavelengths of 500, 1000, and 2000 nm.

FIG. 11 is a graph depicting the system transmittance of a prior art lamp incorporating a typical IR coating.

FIG. 12A is a graph depicting the coating transmittance of a coating designated Coating A, which can be incorporated into an incandescent lamp in accordance with one embodiment of the invention.

FIG. 12B is a graph depicting the coating transmittance of a coating designated Coating B, which can be incorporated into an incandescent lamp in accordance with another embodiment of the invention.

FIG. 12C is a graph depicting the coating transmittance of a coating designated Coating C, which can be incorporated into an incandescent lamp in accordance with another embodiment of the invention.

FIG. 13 is a graph depicting the transmittance of Coating B in the visible wavelength range of 400 to 700 nm, when used in combination with a reflector in a lighting fixture.

FIG. 14A is a graph depicting the system transmittance of an incandescent lamp in accordance with the invention, the lamp incorporating Coating A.

FIG. 14B is a graph depicting the system transmittance of an incandescent lamp in accordance with the invention, the lamp incorporating Coating B.

FIG. 14C is a graph depicting the system transmittance of an incandescent lamp in accordance with the invention, the lamp incorporating Coating C.

FIG. 15A is a graph depicting the transmittance and absorptance of a coating system that includes a first coating in the form of Coating A and a contiguous second coating in the form of a layer of indium tin oxide (ITO) having a plasma wavelength of 1.3 μ.

FIG. 15B is a graph depicting the transmittance and absorptance of a coating system that includes a first coating in the form of Coating B and a contiguous second coating in the form of a layer of indium tin oxide (ITO) having a plasma wavelength of 1.3μ.

FIG. 15C is a graph depicting the transmittance and absorptance of a coating system that includes a first coating in the form of Coating C and a contiguous second coating in the form of a layer of indium tin oxide (ITO) having a plasma wavelength of 1.3μ.

FIG. 16A is a graph depicting the system transmittance and system absorptance of an incandescent lamp incorporating the coating system characterized in FIG. 15A.

FIG. 16B is a graph depicting the system transmittance and system absorptance of an incandescent lamp incorporating the coating system characterized in FIG. 15B.

FIG. 16C is a graph depicting the system transmittance and system absorptance of an incandescent lamp incorporating the coating system characterized in FIG. 15C.

FIG. 17 is a graph depicting the transmittance, reflectance, and absorptance of a coating in the form of a layer of indium tin oxide (ITO) having a plasma wavelength of 1.3μ.

FIG. 18A is a table identifying the successive layers that comprise the coating system represented in FIGS. 15A and 16A and a further layer of indium tin oxide (ITO) having a plasma wavelength of 2.3μ.

FIG. 18B is a table identifying the successive layers that comprise the coating system represented in FIGS. 15B and 16B and a further layer of indium tin oxide (ITO) having a plasma wavelength of 2.3μ.

FIG. 18C is a table identifying the successive layers that comprise the coating system represented in FIGS. 15C and 16C and a further layer of indium tin oxide (ITO) having a plasma wavelength of 2.3μ.

FIG. 19 is a graph depicting the average external emissivity of the coating system identified in FIG. 18C, at 1273K.

FIG. 20 is a side sectional view of a lighting fixture incorporating a conventional, non-coated incandescent lamp located within an elliptical envelope that carries an IR coating.

### DESCRIPTION OF THE PREFERRED EMBODIMENTS

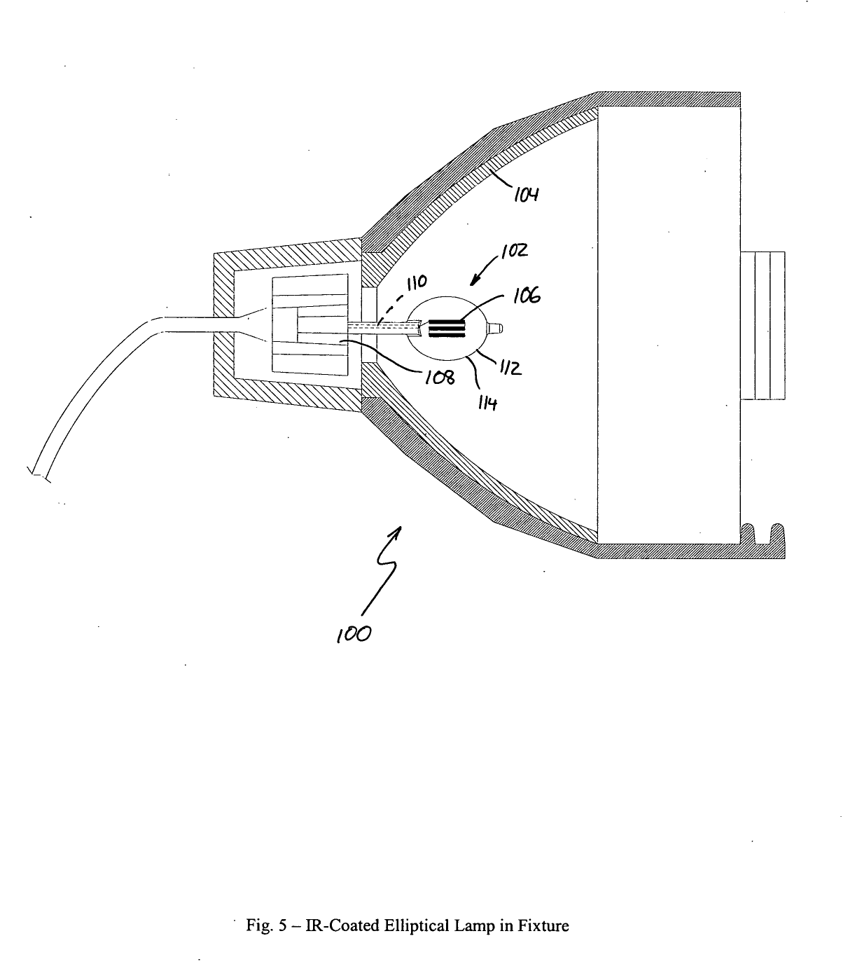

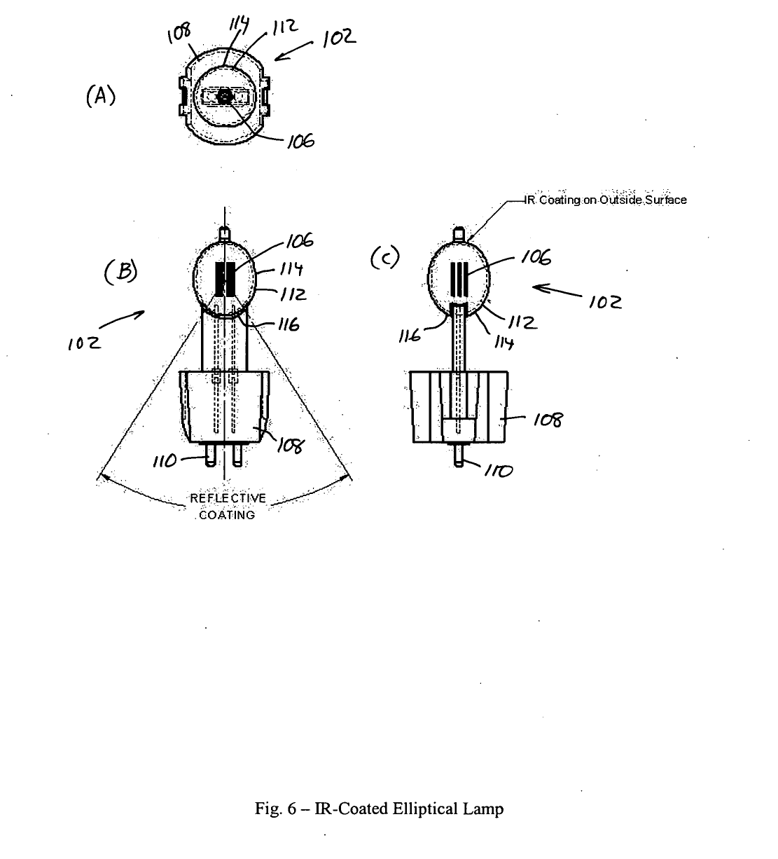

With reference now to the illustrative drawings, and particularly to FIGS. 5 and 6A, 6B, and 6C, there is shown a lighting fixture 100 embodying the present invention, the fixture including an incandescent lamp 102 mounted to a concave reflector 104, with the lamp's filaments 106 being located substantially at a focal point of the reflector. Light emitted by the lamp is reflected by the reflector to project a beam of light. In addition to the filaments, the lamp includes a base 108, a pair of leads 110 forming an electrical connector, and a transparent fused silica envelope 112 enclosing the filaments. The outer surface of the envelope carries on its outer surface a special optical coating 114 configured to transmit a substantial amount of incident visible light, and to reflect back toward the filaments a substantial amount of incident infrared light.

With particular reference to FIGS. 6A, 6B, and 6C, the lamp 102 includes six filaments 106, with each having the form of a helical coil and which are arranged with their longitudinal axes in parallel and uniformly around the lamp's central longitudinal axis. A broadband reflective coating 116 is disposed on a lower portion of the lamp envelope 112, in the vicinity of the base. This reflective coating reflects back toward the filaments any visible and infrared light that otherwise would have been incident on the lamp base, and thus wasted. This coating can significantly improve the lamp's luminous efficacy.

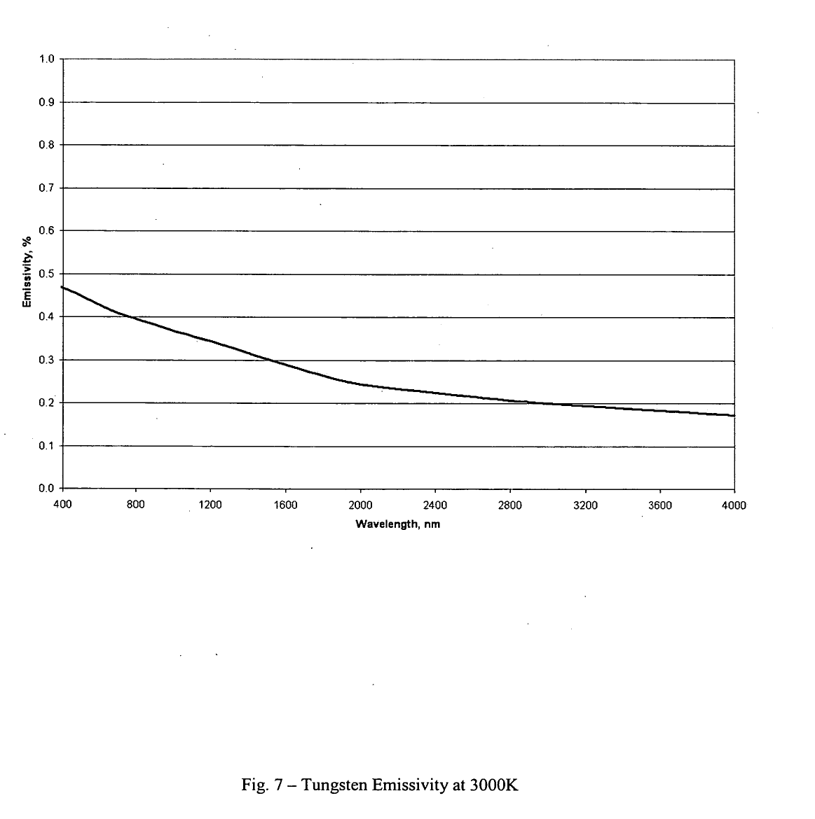

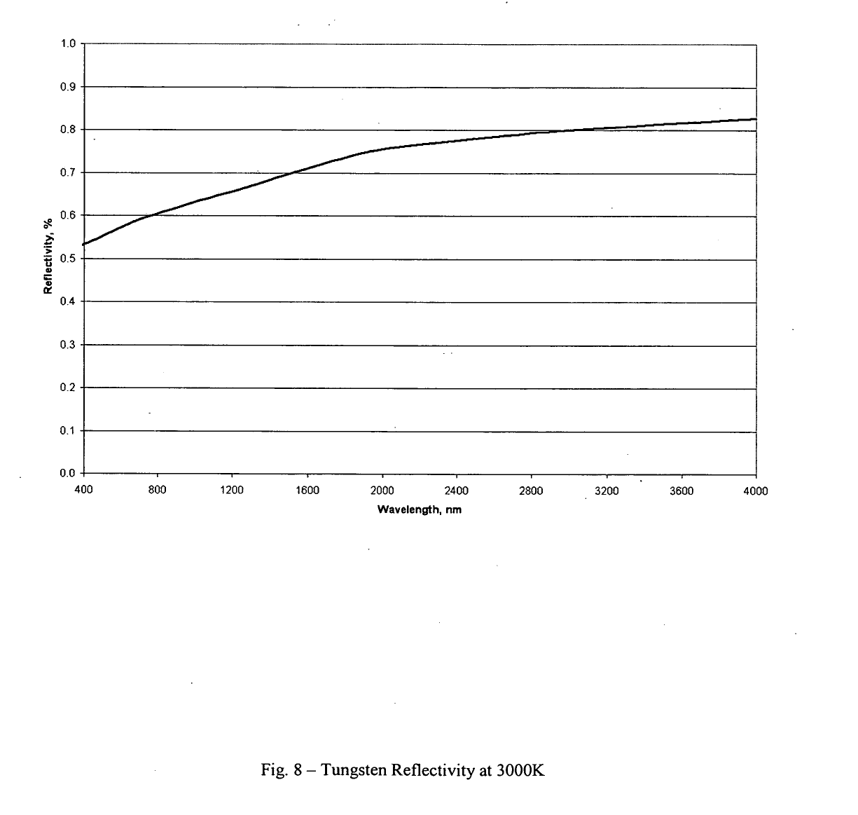

One of the traditional important advantages of forming lamp filaments of tungsten is that this material functions as a spectrally selective emitter, i.e., it has a higher emissivity at visible wavelengths than it does at IR wavelengths. This phenomenon is depicted in FIG. 7. However, an apparently unappreciated negative consequence of this characteristic arises for lamps incorporating IR-reflective coatings, because tungsten has a correspondingly higher reflectivity at IR wavelengths than it does at visible wavelengths. Reflectivity at a given wavelength is equal to unity minus emissivity. This phenomenon is depicted in FIG. 8, which shows that tungsten reflects 63% of IR light at 1000 nm, 75% of IR light at 2000 nm, and 80% of IR light at 3000 nm. Persons skilled in the art of designing IR-reflective coatings for lamp applications might not have fully understood or appreciated the effect the filament's reflectivity has on the overall luminous efficacy of lamps incorporating such coatings.

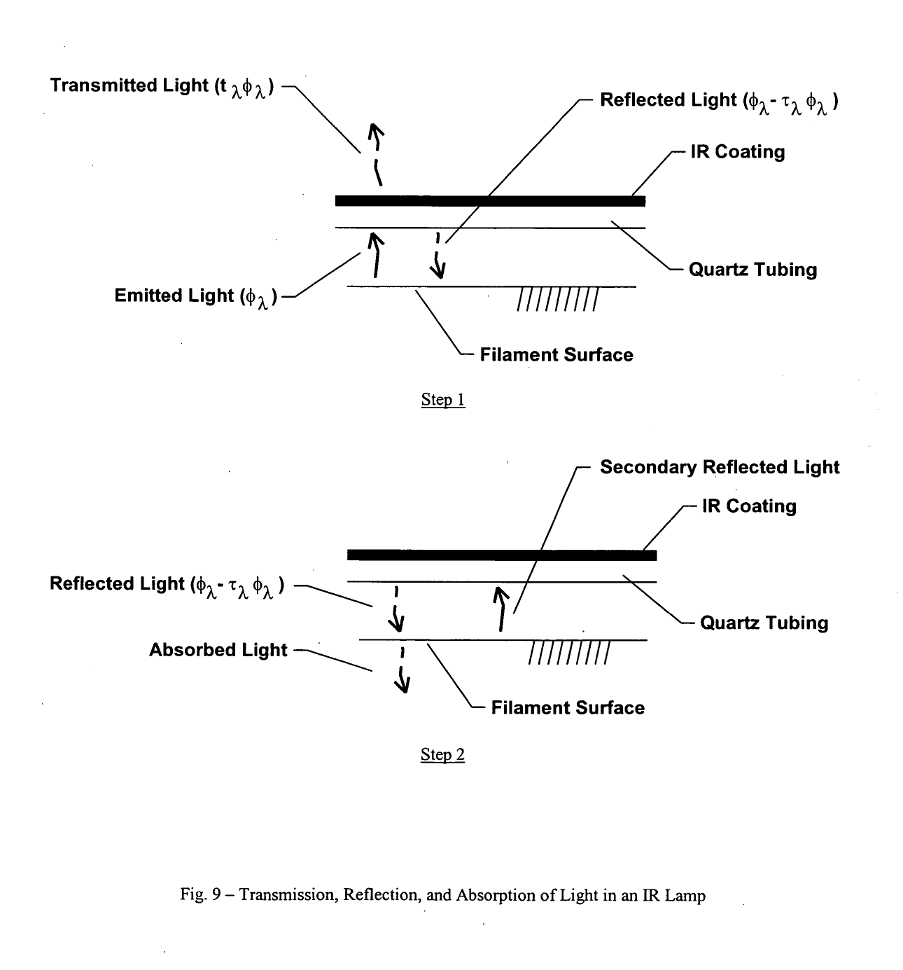

Consequently, a substantial portion of the IR light that is reflected by the IR coating back toward the tungsten filament is, in turn, reflected by the filament back toward the coating. When this twice-reflected IR light strikes the coating a second time, a portion of it is reflected again back toward the filament, but another portion of it is transmitted through, or absorbed by, the coating. The successive reflections continue, essentially constituting an oscillation between the filament and the coating, until the IR light either is absorbed by the filament, is absorbed by the IR coating, or is transmitted from the lamp. This oscillation effect is illustrated in FIG. 9.

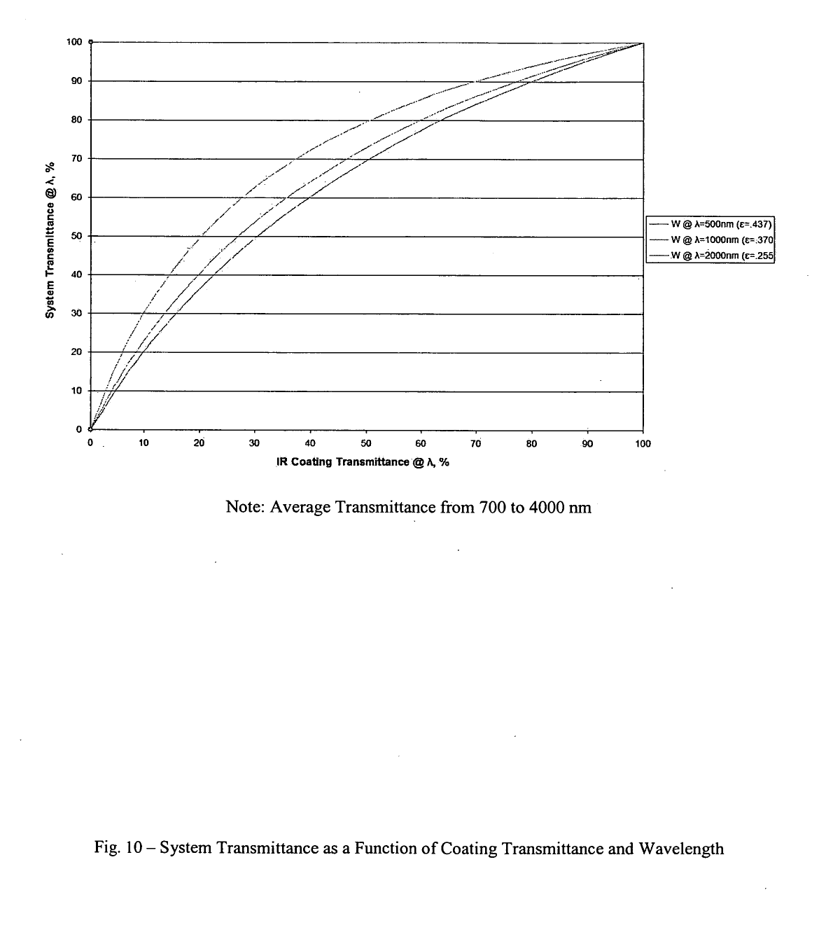

In a dielectric IR coating, which exhibits negligible absorption, summing together the IR light transmitted through the coating both from its initial emission from the filament and from all of the subsequent reflections from the filament yields a value corresponding to the effective transmittance of the incandescent lamp as a system, or its system transmittance. FIG. 10 depicts a coating's system transmittance at three distinct wavelengths (500, 1000, and 2000 nm), as a function of the coating's average transmittance value for just a single incidence, i.e., the coating transmittance. Note that the lamp's system transmittance increases rapidly as the coating transmittance increases, and that, consequently, the lamp's system reflectance decreases rapidly as the coating transmittance increases. For example, for IR light having a wavelength of 2000 nm, the lamp's system transmittance is about 30% when its coating transmittance is 10%, and the lamp's system transmittance is about 63% when its coating transmittance is 30%. In the same example, the lamp's system reflectance is about 70% when its coating transmittance is 10%, and the lamp's system reflectance is about 37% when its coating transmittance is 30%.

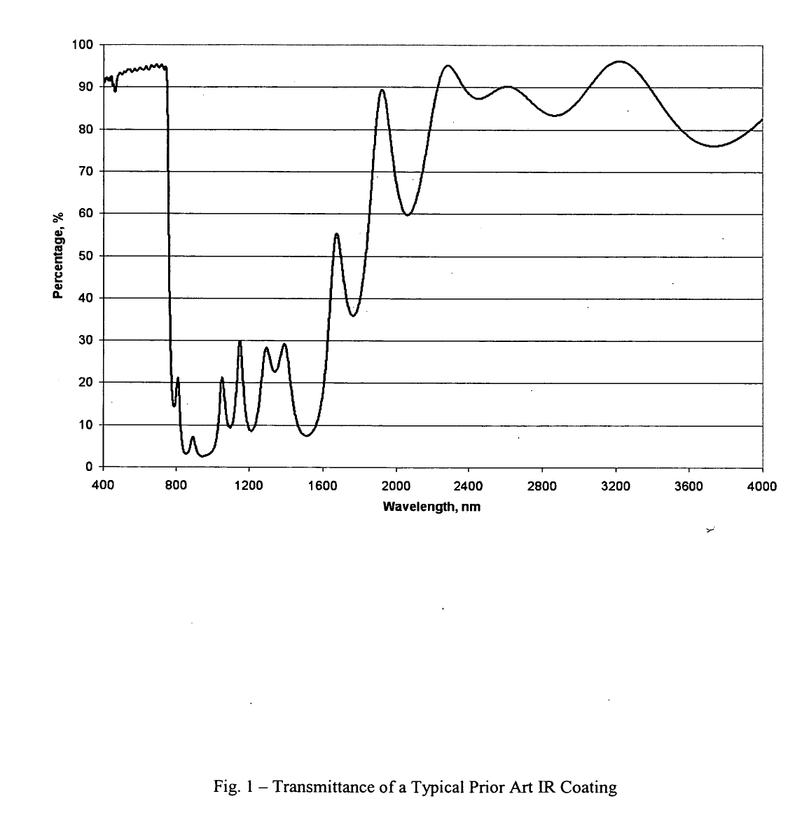

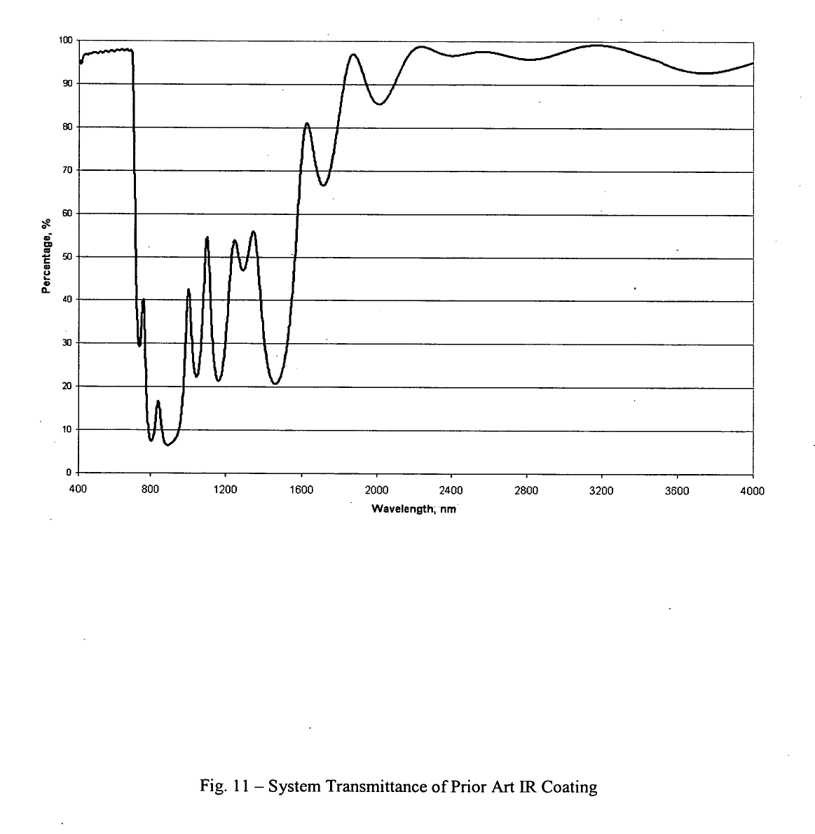

FIG. 11 depicts the system transmittance of an incandescent lamp incorporating the prior art IR coating design of FIG. 1. Because of the high reflectivity of the tungsten filament in the IR region, the prior art coating is now seen to provide substantially higher system transmittance and lower system reflectance of IR light than previously assumed; it is now seen to constitute a substantially poorer IR coating for improving a lamp's luminous efficacy.

It should, therefore, be appreciated that the optimum dielectric IR coating on an incandescent lamp incorporating a tungsten filament is determined by reference to the lamp's system transmittance or reflectance, not its coating transmittance or reflectance. In particular, the optimum dielectric IR coating will provide a minimum integrated sum of the lamp's system transmittance at each wavelength above 700 nm multiplied by the radiated power of the filament at the same wavelength. A tungsten filament incandescent lamp incorporating a dielectric IR coating design optimized by reference to its system transmittance will exhibit a substantially higher luminous efficacy than will a lamp incorporating a coating design optimized by reference only to coating transmittance. In general, according to this new optimization method, the coating's transmittance should be less than 10% (and its reflectance greater than 90%) for all IR wavelengths ranging from 740 nm to the highest possible wavelength. Preferably, the coating transmittance at such wavelengths is as close to 0% as possible, and its reflectance as close to 100% as possible.

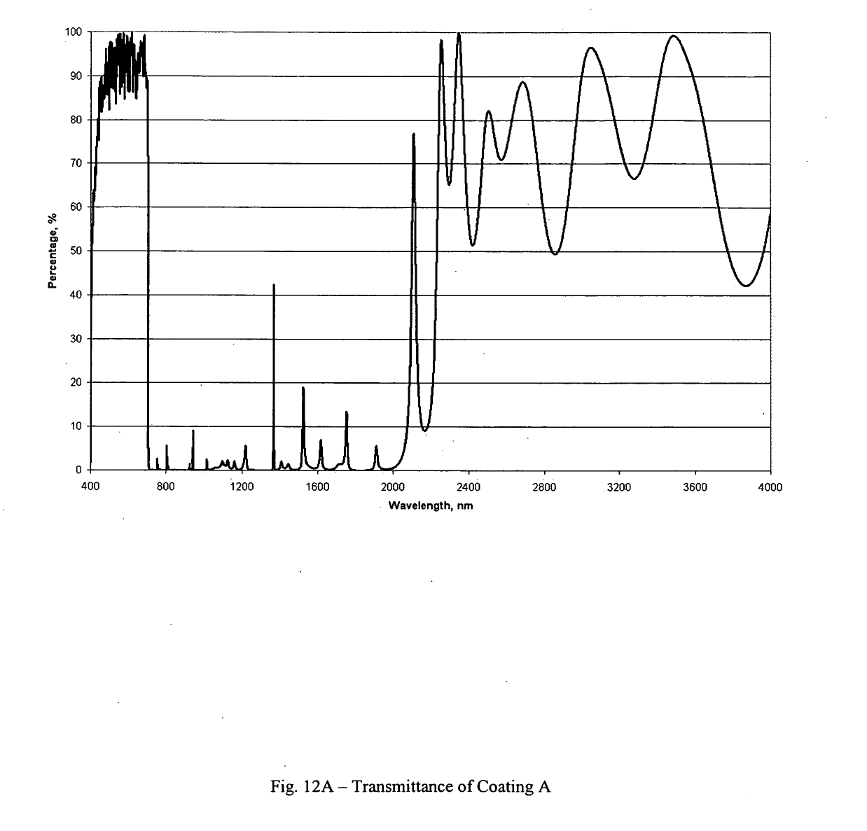

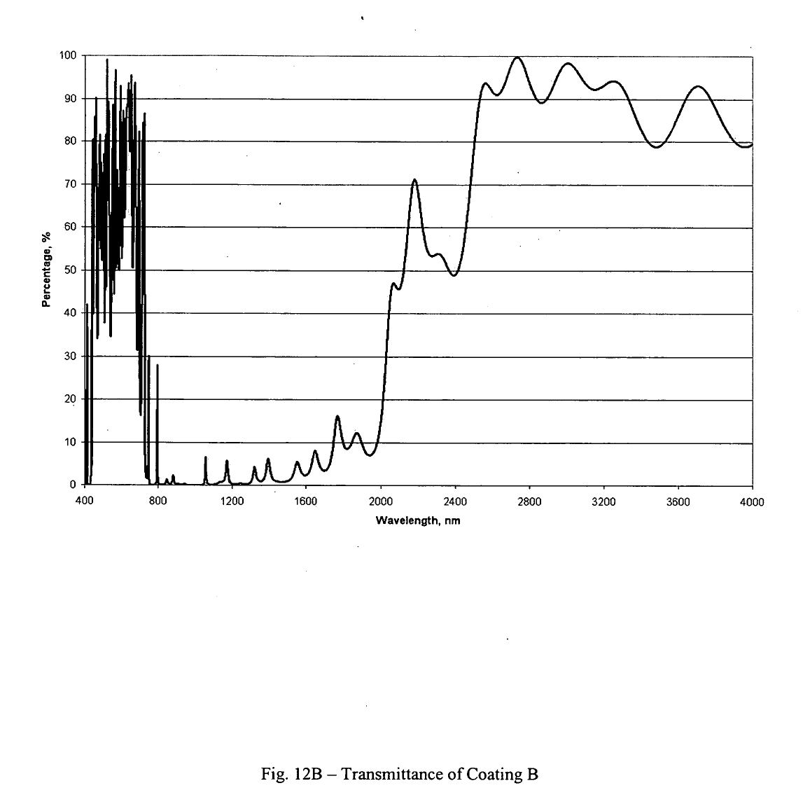

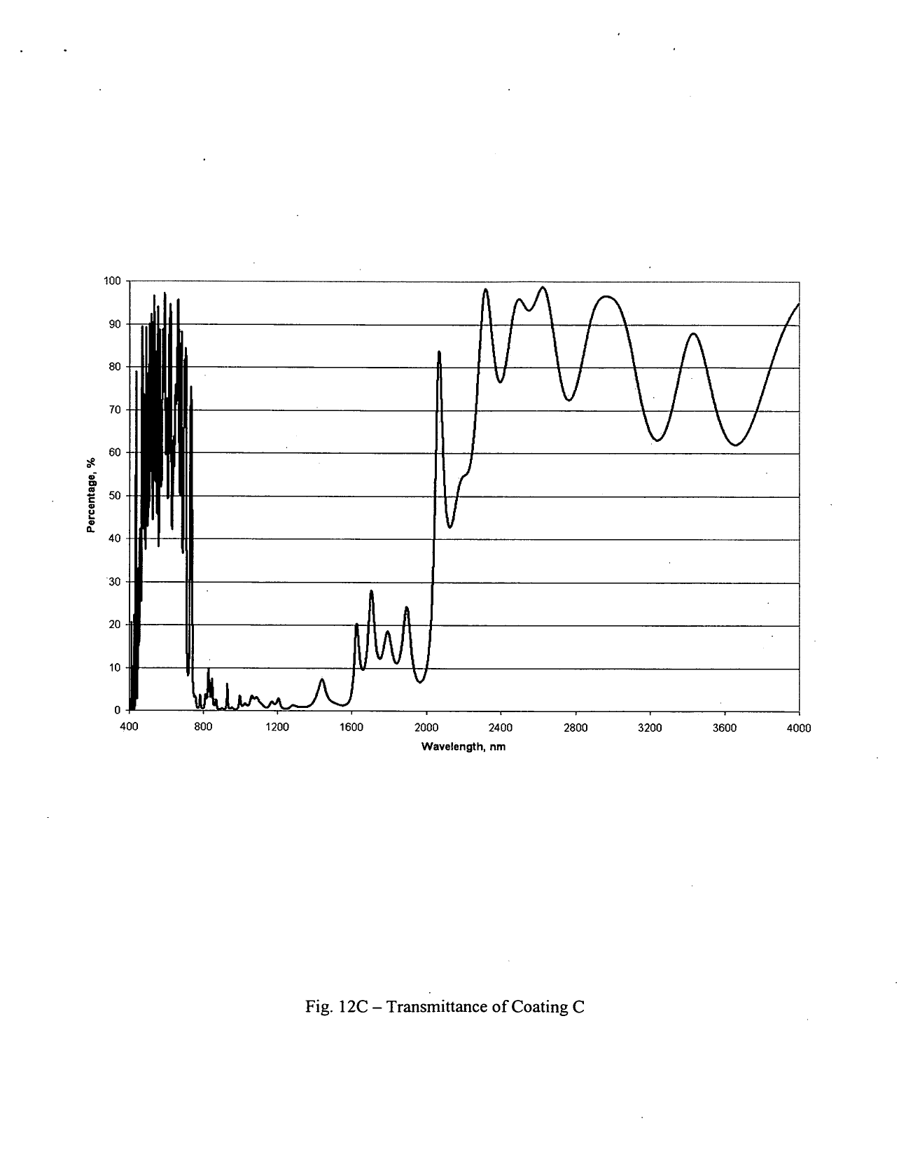

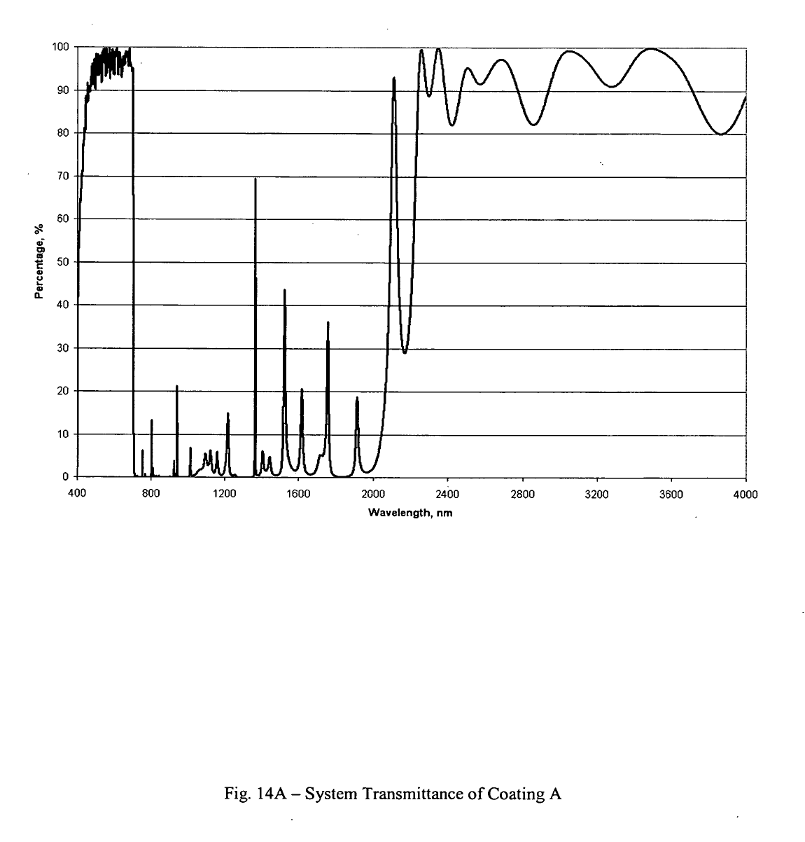

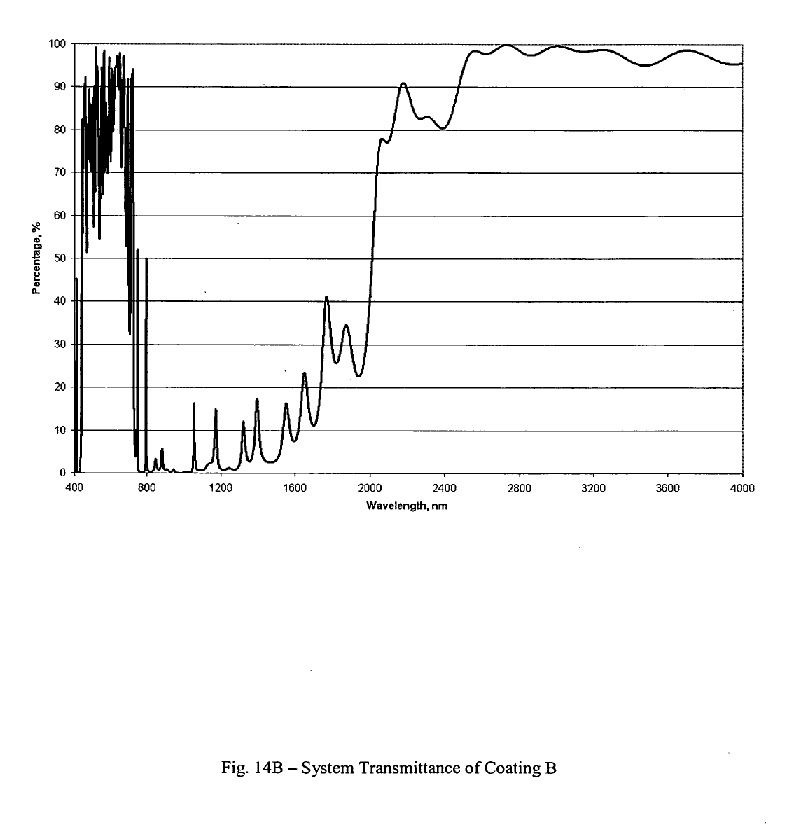

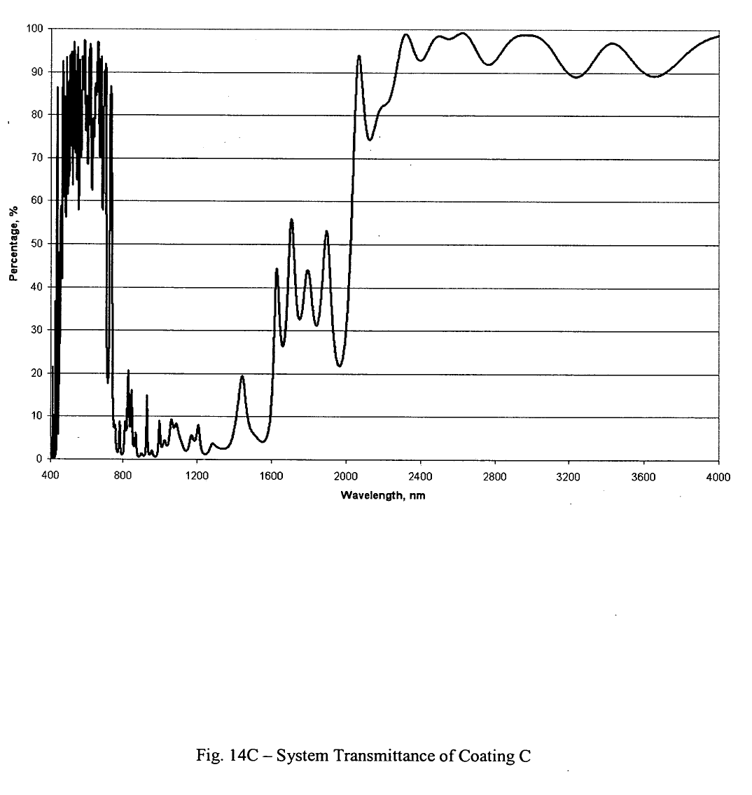

An IR lamp having a higher efficiency than that of the prior art coating represented in FIG. 1 can be produced using an IR coating having a wider IR reflection band and having a higher average IR reflectance within that band. For example, a coating (Coating A) that includes an 88-layer stack of alternating high-index niobia (Nb₂O₅) and low-index silica (SiO₂) can provide an average transmittance of about 88% in the visible wavelength range of 400 to 700 nm and an average reflectance of about 99% in the infrared wavelength range of 740 to 2000 nm. The coating transmittance for Coating A is shown in FIG. 12A, and the system transmittance for a tungsten filament incandescent lamp incorporating such a coating is shown in FIG. 14A. FIG. 14A indicates that the lamp's system transmittance in the infrared wavelength range of 740 to 2000 nm is quite low.

Another exemplary coating in accordance with the invention (Coating B) includes a 54-layer stack of alternating layers of high-index niobia (Nb₂O₅) and low-index silica (SiO₂). As shown in FIG. 12B, this Coating B provides an average transmittance of about 59% in the visible wavelength range of 400 to 700 nm and an average reflectance of about 96% in the infrared wavelength range of 740 to 2000 nm. Although this Coating B design has a significantly lower visible transmittance than does Coating A, it has 40% fewer layers. This increases the coating's actual performance because it includes fewer scattering interfaces, and it provides a more economical and tolerant coating design for manufacturing. It also provides a significantly improved surface quality, which can allow for improved integration with any overlaying layers (e.g., a transparent conductive coating, as described below).

Yet another coating in accordance with the invention (Coating C) includes a 55-layer stack of alternating layers of high-index tantala (Ta₂O₅) and low-index silica (SiO₂). As shown in FIG. 12C, this Coating C provides an average transmittance of about 56% in the visible wavelength range of 400 to 700 nm and an average reflectance of about 93% in the infrared wavelength range of 740 to 2000 nm. This Coating C has the same advantages as does Coating B, but also takes advantage of the lower scattering and higher temperature rating of Ta₂O₅, both of which will improve a lamp's actual luminous efficacy.

It should be noted that the Coatings A, B, and C all provide transmittances in the visible wavelength range of 400 to 700 nm that are less than the “greater than 90% transmittance” values for the coating disclosed in the above-identified U.S. Pat. No. 6,476,556 to Cottaar; however, this reduced transmittance is not considered significant, for the reasons set forth below. This lower transmittance results from a higher reflectance in the visible wavelength range. But a substantial portion of this reflected visible light is reflected back toward the filament, where it is either absorbed as heat or is reflected by the filament back toward the envelope. A lower visible transmittance, therefore, is only slightly detrimental to the lamp's luminous efficacy, because the reflected visible light still contributes either to reheating the filament or to generating luminous flux, both of which increase the lamp's efficacy.

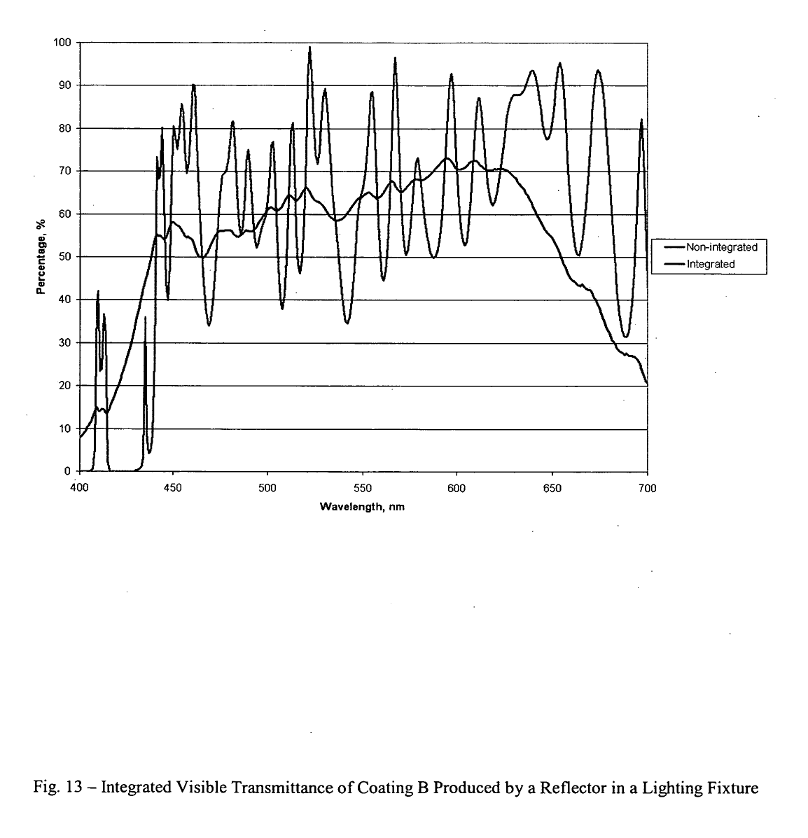

It should be noted further that Coatings A, B, and C were optimized for use in combination with a transparent conductive coating, as described below, and that the layer thicknesses and performance of these coatings would be modified somewhat if they were to be used as dielectric-only coatings. In addition, what appears to be undesirable variations in the visible transmittance of Coatings A, B, and C are in fact integrated in reality into much smoother transmittance curves in a typical fixture. FIG. 13 shows that the integrated visible transmittance of Coating B produced by a reflector in a lighting fixture is substantially smoother than is the original, non-integrated transmittance. This integration is produced by overlaying the shifted transmittance values for the various angles of incidence produced in a typical IR-coated lamp.

It will be noted in FIGS. 14A, 14B, and 14C, however, that even with Coatings A, B, and C, the incandescent lamp still provides a significant system transmittance at wavelengths above 2000 nm. In one feature of the invention, the coating transmittance can be reduced substantially at wavelengths above 2000 nm (and the coating reflectance increased) by combining the dielectric coating with a transparent conductive coating (TCC), incorporating a material such as indium tin oxide (ITO), in an appropriate thickness, carrier concentration, and carrier mobility. The carrier concentration and mobility of a TCC is determined by its doping level and by various deposition parameters known to those skilled in the art. Other suitable conductive materials include, but are not limited to, aluminum-doped zinc oxide (AZO); titanium-doped indium oxide (TIO); cadmium stannate (Cd₂SnO₄); tin oxide-zinc stannate (SnO₂—ZnSnO₃); gallium-doped zinc oxide (GZO); and metals such as thin-film silver and gold.

A TCC can advantageously be substituted for one or more of the high-index refractive layers in the dielectric coating, because conductive coatings, likewise, have relatively high indices of refraction. Alternatively, the TCC can be a final layer overlaying the dielectric coating, which is then sealed with an anti-diffusion layer, such as silica (SiO₂), to prevent further oxidation of the conductive coating at elevated temperatures. In general, a TCC should have low average absorption in the visible wavelength range of 400 to 700 nm, preferably less than 20%, more preferably less than 10%, and most preferably less than 5%. In addition, a TCC should have a high average infrared reflectance in the wavelength range of 2000 to 4000 nm, preferably greater than 70%, more preferably greater than 80%, and most preferably greater than 90%.

A TCC preferably exhibits a uniform, uninterrupted electrical conductance in order for it to provide high IR reflectance. Cracking or crazing in the TCC will reduce its electrical conductance and will substantially reduce its IR reflectance. If surface defects (e.g., pitting, cracking, or crazing) are present in the underlying dielectric coating, they are generally propagated into the TCC. The dielectric coating, therefore, must be deposited using a coating process that will yield an outermost surface substantially free of defects, in order for the TCC to provide the desired optical performance. The TCC itself also must be deposited using a process that does not create cracking or crazing in the TCC. Suitable deposition processes for dielectric coatings and TCCs are known to those skilled in the coating art.

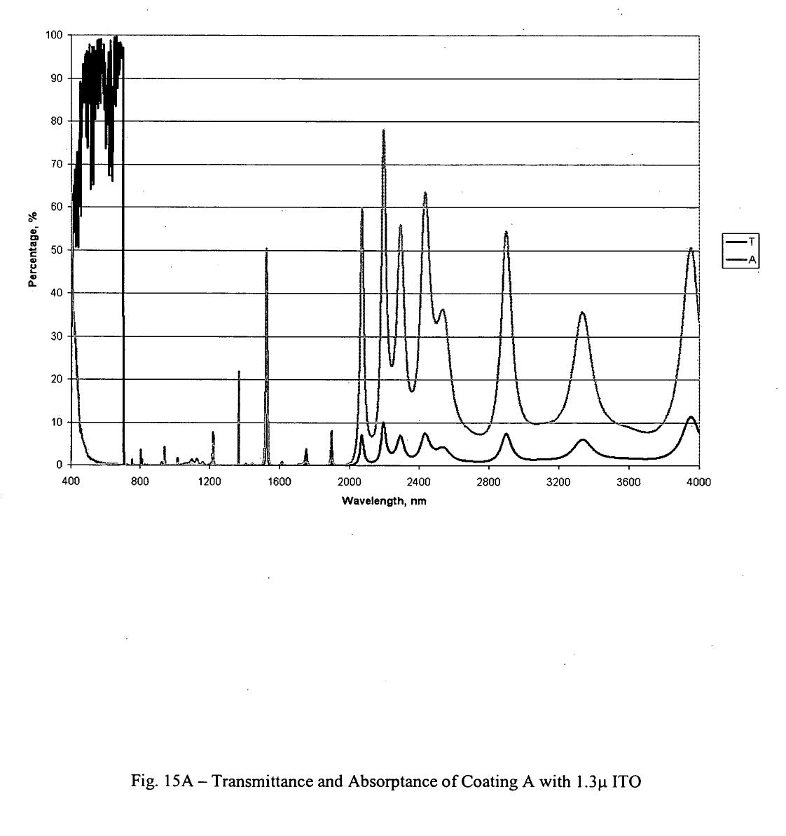

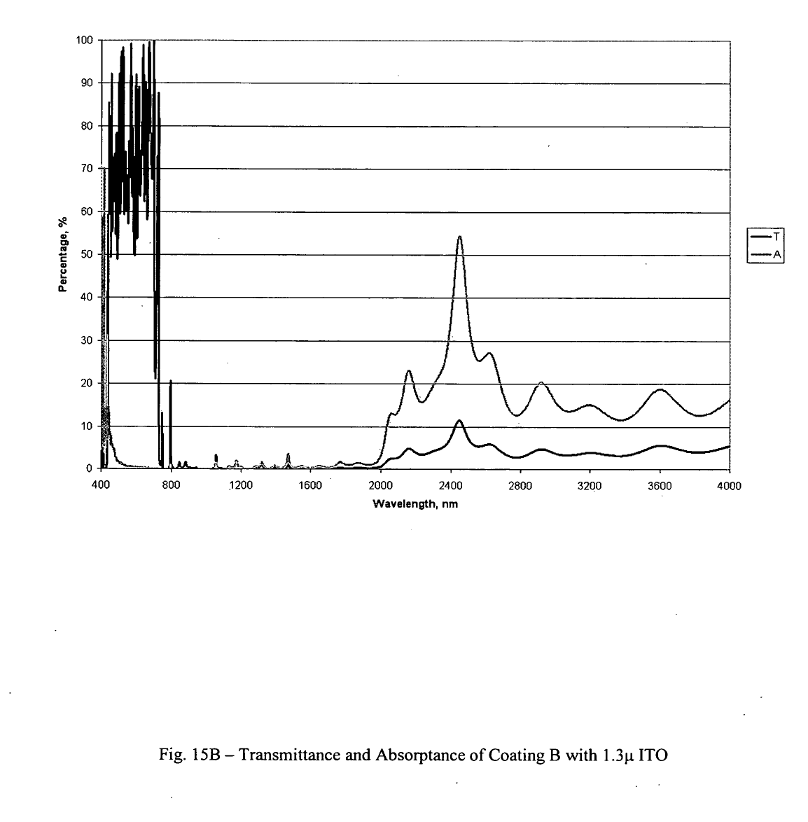

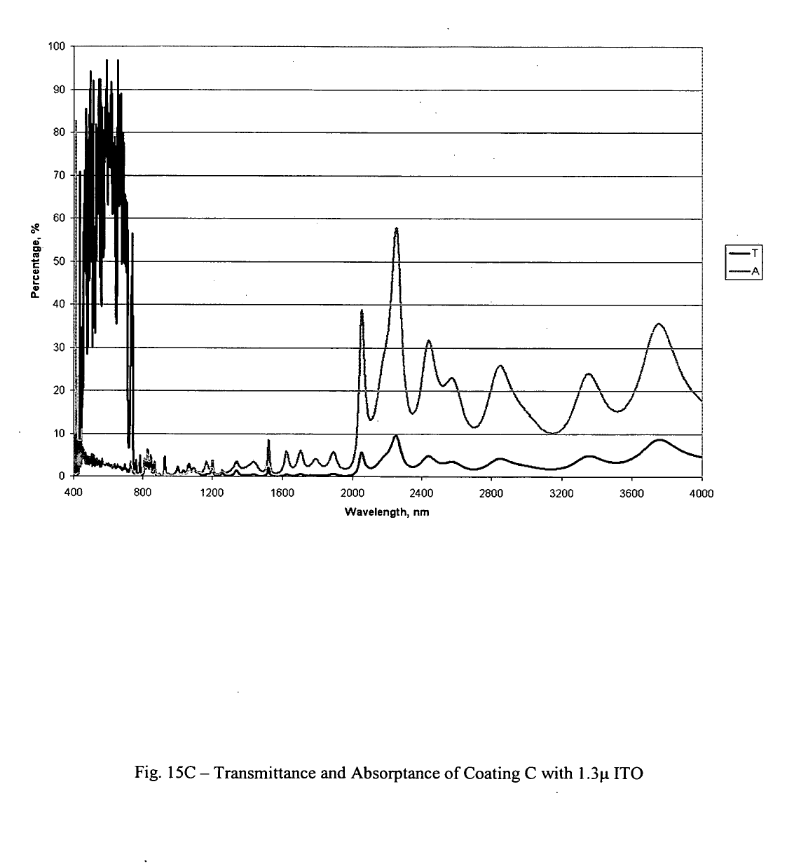

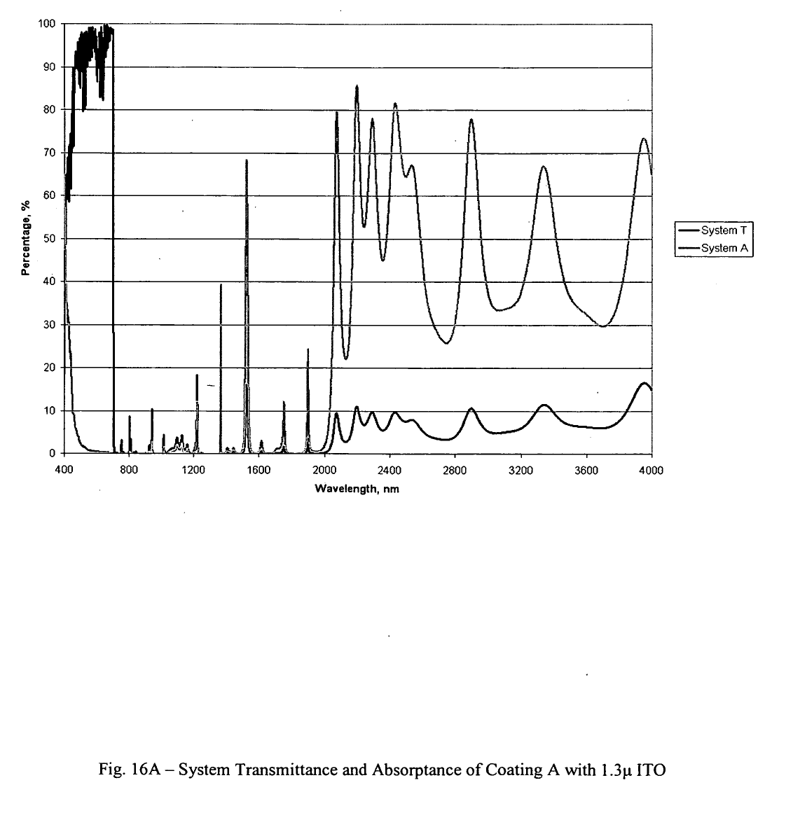

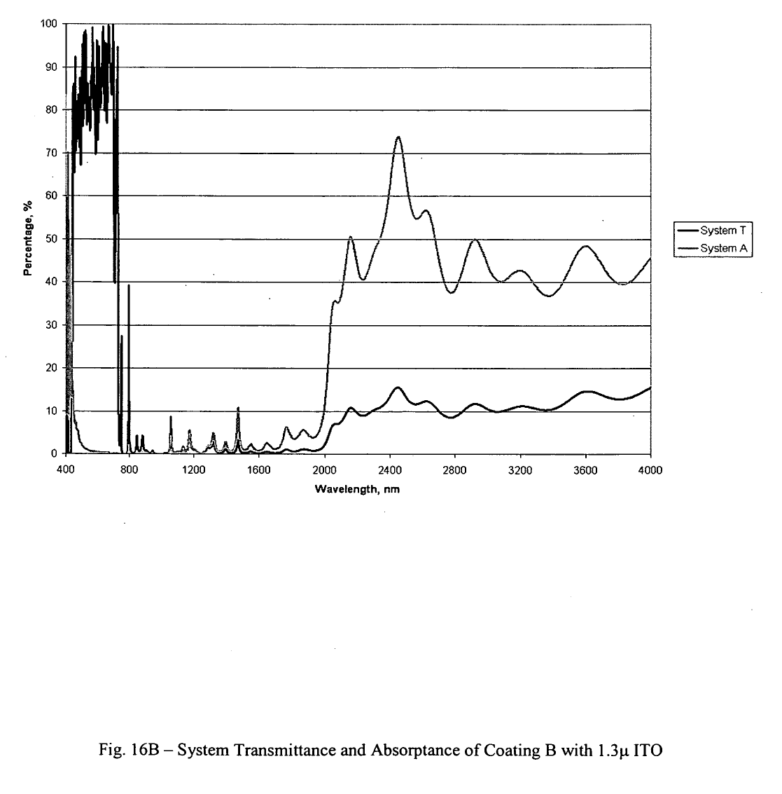

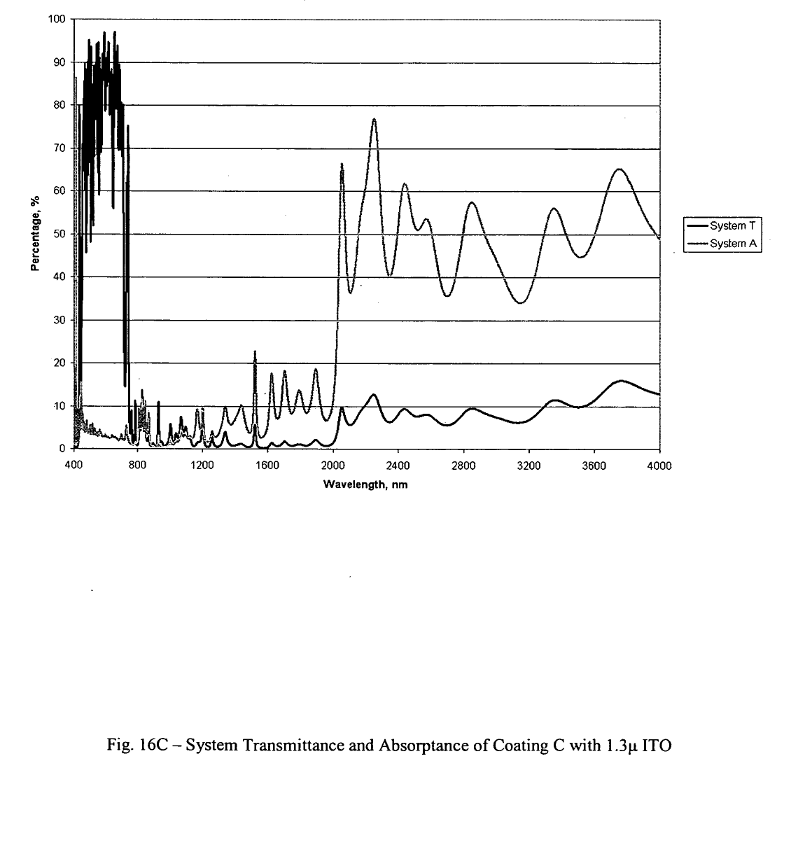

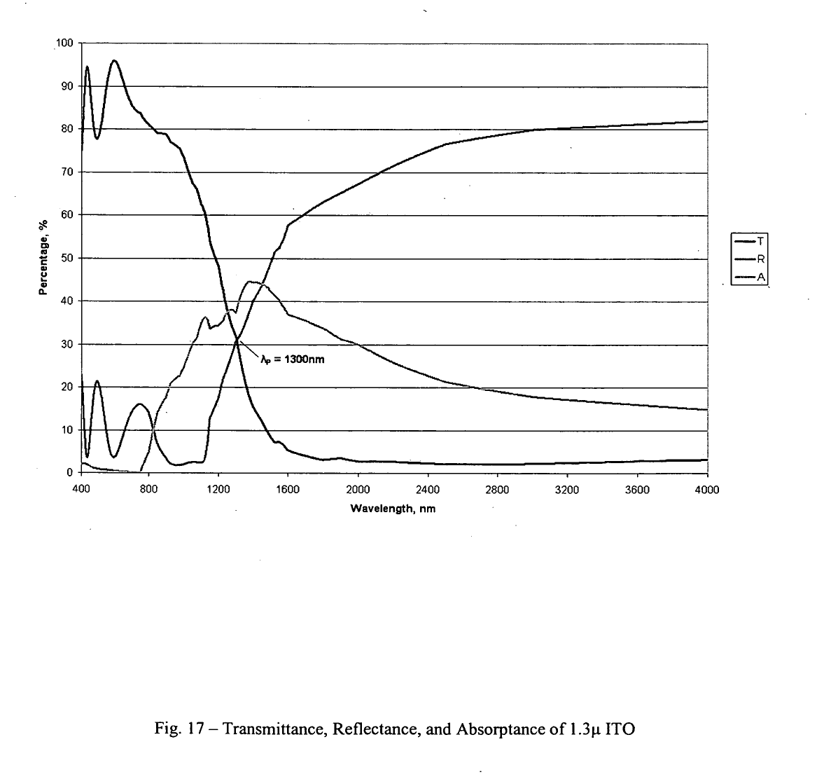

As shown in FIG. 15A, Coating A combined with a 310 nm layer of 1.3μ ITO (reference FIG. 17) provides an average transmittance of about 2% in the infrared wavelength range of 740 to 4000 nm, and an average absorptance of about 21% in the infrared wavelength range of 2000 to 4000 nm. As shown in FIG. 15B, Coating B combined with a 310 nm layer of 1.3μ ITO provides an average transmittance of about 2% in the infrared wavelength range of 740 to 4000 nm, and an average absorptance of about 18% in the infrared wavelength range of 2000 to 4000 nm. As shown in FIG. 15C, Coating C combined with a 310 nm layer of 1.3μ ITO provides an average transmittance of about 2% in the infrared wavelength range of 740 to 4000 nm, and an average absorptance of about 21% in the infrared wavelength range of 2000 to 4000 nm. Also, as shown in FIGS. 16A, 16B, and 16C, the system transmittance of these combined coatings is very low, and the system absorptance of these coatings, likewise, is relatively low.

TCCs such as ITO coatings, of course, also can be combined with other IR coatings, e.g., the IR coating represented by FIG. 1 and the IR coating disclosed in the identified Cottaar patent, to provide incandescent lamps having improved luminous efficacies. It should be appreciated that a TCC having a IR reflectance in the wavelength range of 2000 to 4000 nm that is higher than that of the 1.3μ ITO coating, when combined with Coatings A, B, or C, or other IR coatings, will produce substantially higher efficiencies than these same coatings combined with a 1.3μ ITO coating.

Although Coatings A, B, and C incorporate only two materials (a high refractive index material and a low refractive index material), dielectric coatings incorporating high, medium, and low refractive index materials (three material systems) alternatively can be used according to the invention. These alternative dielectric coatings will ordinarily exhibit the desirable characteristic of producing fewer interference effects in the visible portion of the spectrum. Suitable low-index materials include SiO₂ and Al₂O₃, suitable high-index materials include TiO₂, Ta₂O₅, and Nb₂O₅, and suitable medium-index materials include Y₂O₃, HfO₂, and ZrO₂. Low-, medium-, and high-index layers alternatively can incorporate combinations of any of the materials listed above. For example, a high-index layer can incorporate a combination of Nb₂O₅ and Ta₂O₅.

According to the invention, the two- and three-material coating systems, when illuminated at normal incidence, will transmit less than 90% average over the visible spectrum of 400 to 700 nm and will reflect more than 90% average over the IR spectrum of 740 to 2000 nm. The various coatings described above may be formed using any of a number of known deposition processes. These processes include atomic layer deposition, physical vapor deposition (PVD), reactive sputtering, low-pressure chemical vapor deposition (LP-CVD), and plasma-enhanced chemical vapor deposition (PE-CVD).

The TCC layer(s) included in the dielectric/TCC combination coating system is preferably located on the side of the coating opposite the filament. This minimizes the amount of IR light incident on the TCC and thereby minimizes the adverse effects of the layer's relatively high absorptance in the transition region.

In addition, in the case of a TCC layer(s) formed of ITO or similar material, the effectiveness of the layer in reducing the lamp's system IR transmittance (and increasing its IR system reflectance) can be optimized by varying its thickness and its carrier concentration. Carrier concentration is a function of doping level and various deposition parameters. The carrier concentration and the ITO layer thickness are varied until maximum efficacy is obtained for the coating in combination with a given dielectric stack. Maximum efficacy is obtained by centering the plasma frequency (i.e., the frequency at which transmittance equals reflectance), and the associated high absorption spectral region of the TCC, in the spectral region where high IR reflectivity is provided by the dielectric coating. The plasma frequency of the conductive coating is moved to a wavelength as low as possible, until the high absorption region of the coating terminates just above the visible wavelengths, i.e., 700 nm. The most desirable plasma frequency for an ITO coating produced by sputtering is approximately about 1400 nm or less. This differs substantially from ITO coatings used in most commercial applications, which typically have plasma frequencies between 1800 and 2500 nm, and which have not been used in combination with a dielectric coating on an incandescent lamp.

FIG. 17 depicts the transmittance, reflectance, and absorption of an ITO layer having a thickness of 310 nm and a plasma frequency of approximately 1300 nm. It will be noted that this ITO layer has an absorption of only about 1% average in the visible wavelength range. It also will be noted that the ITO layer has high absorption in the IR-wavelength range of 740 to 2000 nm. The adverse effects of this high absorption band are substantially avoided by the presence of a wide-band dielectric stack, such as Coating A, which reflects IR light in this band before it reaches the ITO layer.

Since TCCs absorb rather than transmit non-reflected IR light, a combination dielectric and TCC will tend to operate at much higher temperatures than a dielectric-only coating. In order to keep an IR coated lamp relatively compact and effective at redirecting the IR light onto the filament, it is desirable to make the outer emissivity of the coating system as high as possible. This can be accomplished by adding an IR-emissive (IRE) coating on top of the TCC layer. An example of such an IRE material is ITO having a plasma frequency equal to the peak emission frequency produced by the lamp envelope. For example, at the maximum operating temperature of fused silica, 1000° C., an ITO layer having a plasma frequency of 2.3μ is most desirable. A diffusion barrier preferably is provided between the TCC and the IRE, in order to prevent degradation of both materials' optical properties at high temperatures.

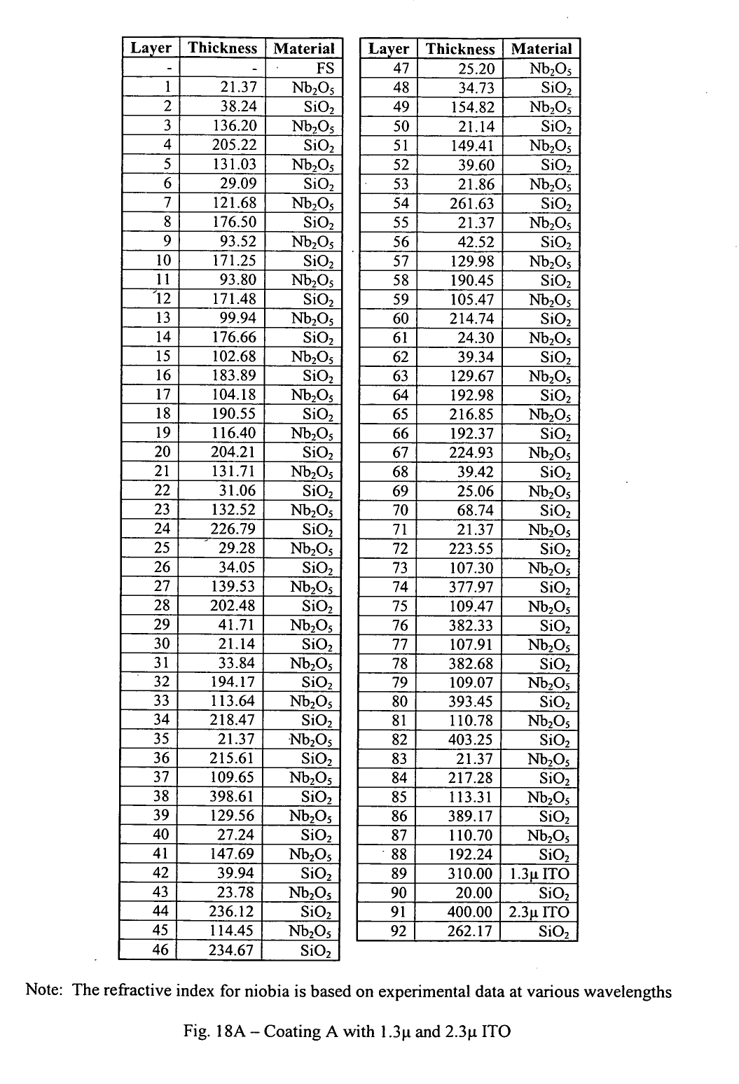

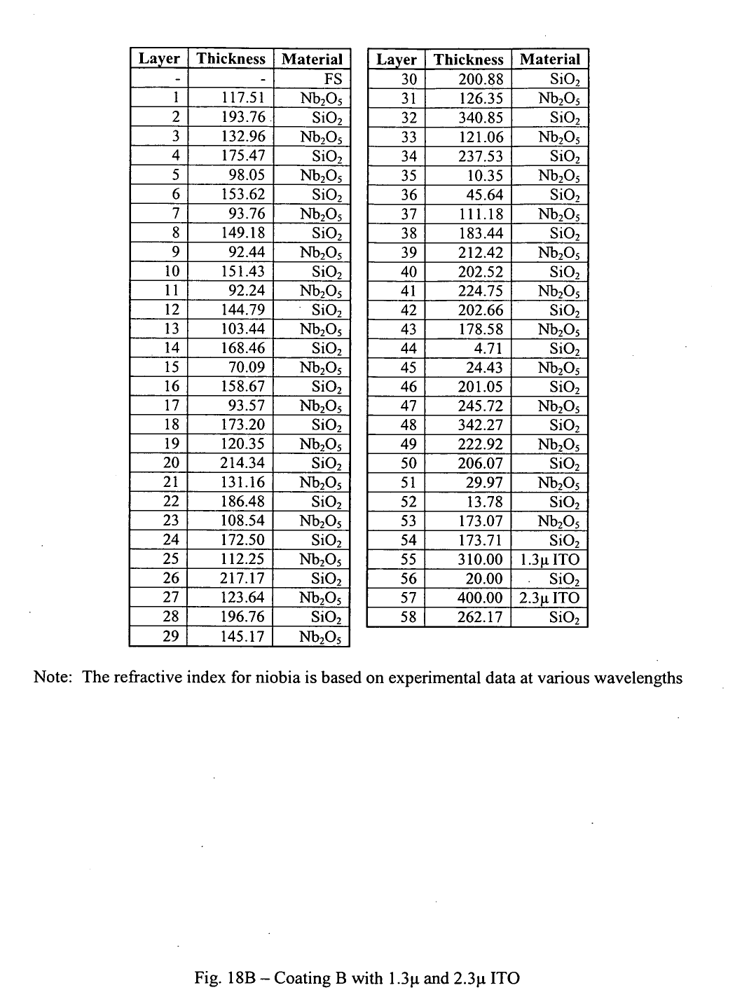

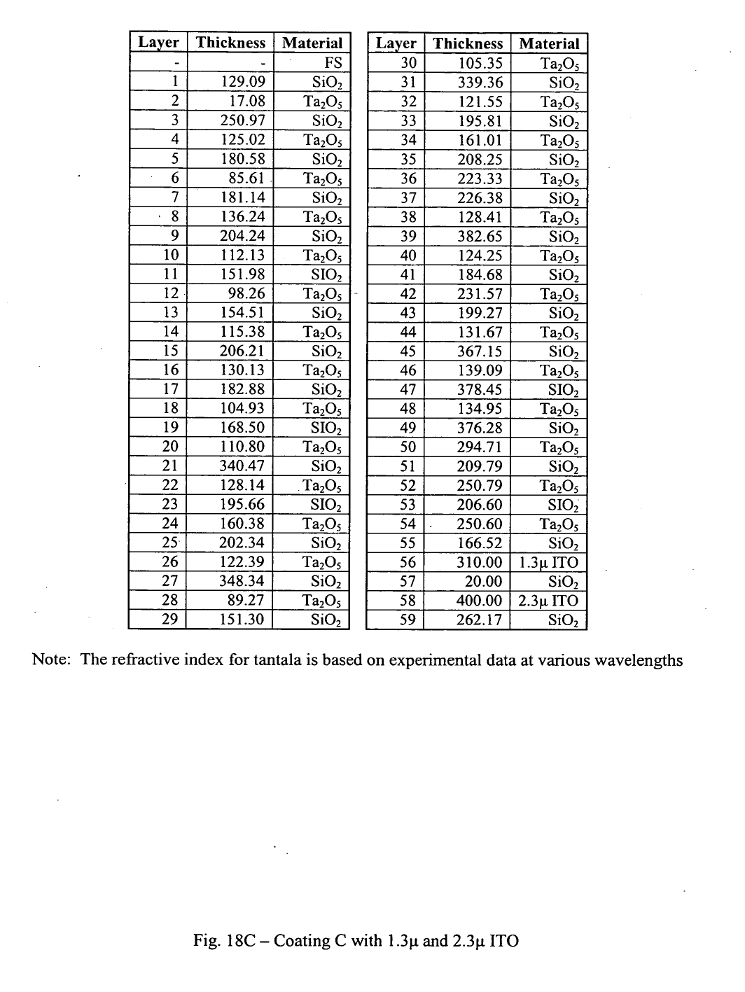

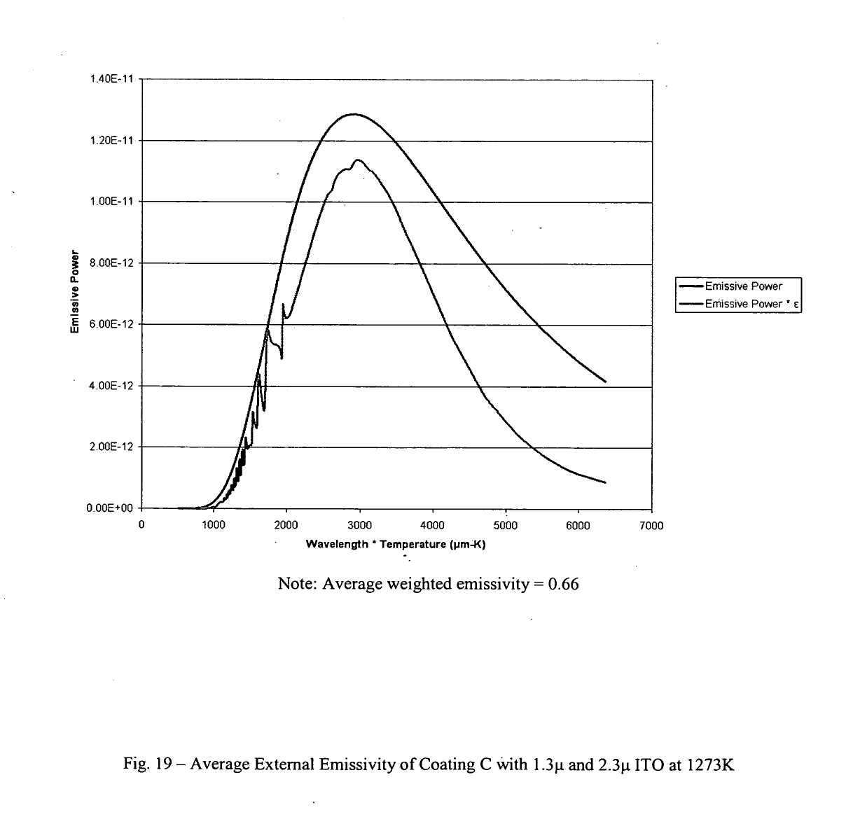

An example of a dielectric/ITO/IRE coating system is shown in FIGS. 18A, 18B, and 18C. The coating system consists of alternating layers of niobia or tantala and silica (forming the dielectric coating), a 1.3μ ITO and silica layer (forming the conductive coating), and a 2.3μ ITO and silica layer (forming the IRE coating and oxygen diffusion barrier). The spectral performance of these coating systems are shown in FIG. 15A, B, and C. The external emissivity of one coating system (Coating C/ITO/IRE) is shown in FIG. 19. With an average weighted emissivity of 0.66, this coating system allows a relatively compact IR coated lamp. Without the final IRE coating, a given IR lamp would require approximately twice the surface area and size to maintain the same envelope temperature.

It should be noted that the silica layer adjacent to either the 1.3μ ITO layer or the IRE layer is a dielectric layer, and it may also include additional dielectric layers (including both high- and low-refractive index materials) to improve the optical performance of a given coating.

The luminous efficacy of an incandescent lamp (η) is defined as the total luminous flux generated by a lamp (Φ) divided by the electrical power consumed by the lamp (P). The following table summarizes the approximate luminous efficacies of linear incandescent lamps incorporating envelopes coated with the various coatings which have been discussed above. It will be noted that a lamp incorporating the prior art IR coating represented in FIG. 1 provides a 39% improvement over an uncoated lamp. It also will be noted that a lamp incorporating Coatings A, B, and C provide significantly greater improvement over an uncoated lamp. Lastly, lamps incorporating Coatings A, B, and C in combination with 1.3μ ITO coating provide an even more significant improvement over an uncoated lamp, providing up to 2.6 times the luminous flux at a given electrical power level.

TABLE

| | Approximate Luminous Efficacy | |
|---|---|---|
| Description | at 3200° K, LPW | Improvement |
| No Coating | 28 | — |
| Prior Art IR Coating | 39 | 39% |
| Coating A | 66 | 135% |
| Coating B | 48 | 70% |
| Coating C | 44 | 57% |
| Coating A/ITO | 74 | 163% |
| Coating B/ITO | 64 | 130% |
| Coating C/ITO | 59 | 109% |

The invention is embodied in an incandescent lamp having an extended high-reflectivity IR coating on its envelope, with the coating being configured such that the lamp provides an improved system transmittance as compared to a lamp incorporating an envelope that is uncoated or coated with a prior art IR coating like that characterized in FIG. 1. The lamp of the invention provides a system efficacy of at least about 40 LPW, or more preferably more than about 60 LPW, and most preferably more than about 80 LPW for incandescent lamps having an average operating life of at least 300 hours.

In an alternative embodiment of the invention, the lamp can be configured not to emit white light, but rather a narrower band of colored light. Specifically, the coating placed on the lamp's envelope can be configured to transmit the desired band of colored light, and to reflect not only IR light but also visible light outside the desired band. In the case of a lamp configured to emit blue light, this can be accomplished simply by configuring the coating to have a cutoff wavelength that is lower than it is in the case of the IR coating discussed above, i.e., a wavelength of about 540 nm rather than 740 nm. Alternatively, in the case of a lamp configured to emit some other visible color band, e.g., a red color band, this can be accomplished by configuring the lamp coating to transmit the desired red color band but reflect all wavelengths both above and below that band. If the conductive coating feature of the invention is to be used in a lamp that generates such a color band, such coating's thickness, doping, and carrier concentration should be optimized for that particular configuration. For example, for blue light, the conductive coating's plasma frequency could be reduced to increase the lamp's efficacy, because the increased ITO absorption between 540 and 740 nm would not affect the lamp's desired blue spectral output.

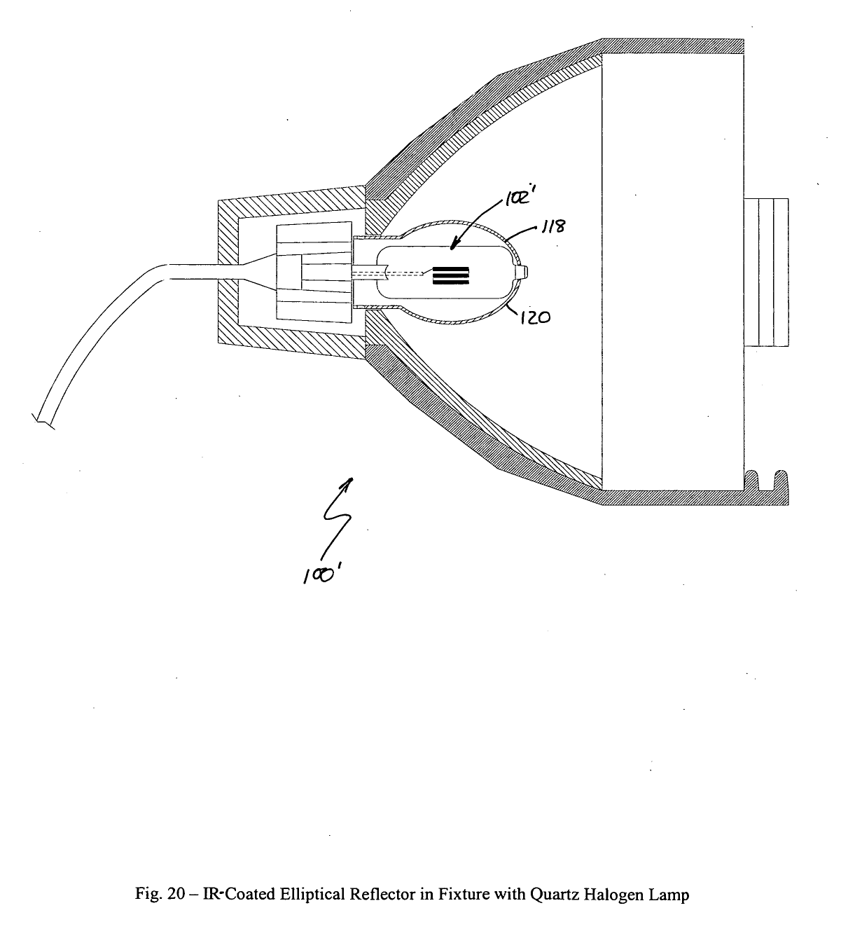

FIG. 20 depicts a lighting fixture 100′ similar to the lighting fixture 100 of FIG. 5, but in this case incorporating a fixed transparent envelope 118 surrounding a conventional, uncoated quartz halogen lamp 102′. An IR coating 120 corresponding to one of the coatings described above is located on the outer surface of this fixed transparent envelope. The envelope 118 has an ellipsoidal shape, with the ellipsoid's two focal points coincident with the ends of the filaments of the lamp. This lighting fixture embodiment has the advantage of enabling use with conventional, uncoated (and thus less expensive) lamps.

It should be appreciated from the foregoing description that the present invention provides an incandescent lamp incorporating a special optical coating system that enables the lamp to provide an improved luminous efficacy. In one form, the optical coating system includes a plurality of dielectric layers having prescribed refractive indices and prescribed thicknesses, which are selected such that the optical coating provides a prescribed transmittance/reflectance spectrum having an average reflectance greater than 90% across an infrared wavelength range of 740 to 2000 nm and further having an average transmittance of less than 90% across a visible wavelength range of 400 to 700 nm. In another form, the optical coating system includes two distinct coatings: (1) a first coating including a plurality of dielectric layers having prescribed refractive indices and prescribed thicknesses, which are selected such that the first coating provides a prescribed transmittance/reflectance spectrum, and (2) a second coating including a transparent conductive material configured such that the second coating provides a prescribed transmittance/reflectance spectrum. The invention also is embodied in a lighting fixture incorporating an optical coating as described above, located either on the envelope of the incandescent lamp, itself, or on another substrate of the fixture, separate and apart from the lamp, e.g., a fixed transparent envelope surrounding the incandescent lamp.

Although the invention has been described with reference only to the preferred embodiments, those skilled in the art will appreciate that various modifications can be made without departing from the invention. Accordingly, the invention is defined only by the following claims.

1. An incandescent lamp comprising:
a filament;
a transparent envelope defining an enclosed space in which the filament is located; and
an optical coating disposed on a surface of the envelope, for transmitting light emitted by the filament in a prescribed visible wavelength band, while reflecting back toward the filament light emitted by the filament in other wavelength bands, whereupon a portion of such reflected light is absorbed by the filament;
wherein the optical coating includes a plurality of dielectric layers having prescribed refractive indices and prescribed thicknesses, which are selected such that the optical coating provides a prescribed transmittance/reflectance spectrum having an average reflectance greater than 90% across an infrared wavelength range of 740 to 2000 nm and further having an average transmittance of less than 90% across a visible wavelength range of 400 to 700 nm;
and wherein the optical coating cooperates with the filament such that the lamp provides a higher luminous efficacy than would a corresponding lamp lacking such an optical coating.

2. An incandescent lamp as defined in claim 1, wherein the optical coating is configured such that the lamp has a luminous efficacy of at least 40 lumens per watt.

3. An incandescent lamp as defined in claim 1, wherein the optical coating is configured such that the lamp has a luminous efficacy of at least 60 lumens per watt.

4. An incandescent lamp as defined in claim 1, wherein the optical coating is configured such that the lamp has a luminous efficacy of at least 80 lumens per watt.

5. An incandescent lamp as defined in claim 1, wherein the optical coating is located on the outer surface of the transparent envelope.

6. An incandescent lamp as defined in claim 1, wherein the refractive indices and thicknesses of the dielectric layers of the optical coating are selected such that the optical coating provides a transmittance/reflectance spectrum having an average reflectance greater than 95% across an infrared wavelength range of 740 to 2000 nm.

7. An incandescent lamp as defined in claim 1, wherein:
the optical coating includes a stack of alternating layers of high- and low-refractive index materials;
the high-refractive index layers all incorporate a material selected from the group consisting of TiO₂, Ta₂O₅, NbO₂, and mixtures thereof, and
the low-refractive index layers all incorporate a material selected from the group consisting of SiO₂, Al₂O₃, and mixtures thereof.

8. An incandescent lamp as defined in claim 1, wherein the optical coating further includes one or more transparent electrically conductive layers.

9. An incandescent lamp as defined in claim 8, wherein the one or more transparent electrically conductive layers are contiguous with the plurality of dielectric layers.

10. An incandescent lamp as defined in claim 8, wherein the one or more transparent electrically conductive layers are configured to have an average reflectance greater than 70% across an infrared wavelength range of 2000 to 4000 nm.

11. An incandescent lamp as defined in claim 1, and further comprising:
an electrical connector to which the transparent envelope is secured; and
a reflective coating disposed on a portion of the transparent envelope adjacent to the electrical connector, for reflecting visible and infrared light back toward the filament.

12. A lighting fixture comprising:
a housing;
a lamp socket carried by the housing; and
an incandescent lamp comprising
an electrical connector configured to be removably secured to the lamp socket,
a filament,
a transparent envelope secured to the electrical connector and defining an enclosed space in which the filament is located, and
an optical coating disposed on a surface of the envelope, for transmitting light emitted by the lamp filament in a prescribed visible wavelength band, while reflecting back toward the filament light emitted by the filament in other wavelength bands, whereupon a portion of such reflected light is absorbed by the filament;
wherein the optical coating includes a plurality of dielectric layers having prescribed refractive indices and prescribed thicknesses, which are selected such that the optical coating provides a prescribed transmission/reflection spectrum having an average reflectance greater than 90% across an infrared wavelength range of 740 to 2000 nm and further having an average transmittance of less than 90% across a visible wavelength range of 400 to 700 nm;
and wherein the optical coating cooperates with the filament such that the lighting fixture provides a higher luminous efficacy than would a corresponding lighting fixture lacking such an optical coating.

13. A lighting fixture comprising:
a housing;
a lamp socket carried by the housing; and
an incandescent lamp comprising
an electrical connector configured to be removably secured to the lamp socket,
a filament, and
a transparent envelope secured to the electrical connector and defining an enclosed space in which the filament is located;
wherein the lighting fixture further comprises an optical coating for transmitting light emitted by the lamp filament in a prescribed visible wavelength band, while reflecting back toward the filament light emitted by the filament in other wavelength bands, whereupon a portion of such reflected light is absorbed by the filament;
wherein the optical coating includes a plurality of dielectric layers having prescribed refractive indices and prescribed thicknesses, which are selected such that the optical coating provides a prescribed transmittance/reflectance spectrum having an average reflectance greater than 90% across an infrared wavelength range of 740 to 2000 nm and further having an average transmittance of less than 90% across a visible wavelength range of 400 to 700 nm;
and wherein the optical coating cooperates with the filament such that the lighting fixture provides a higher luminous efficacy than would a corresponding lighting fixture lacking such an optical coating.

14. A lighting fixture as defined in claim 13, wherein the optical coating is disposed on a surface of the transparent envelope of the incandescent lamp.

15. A lighting fixture as defined in claim 14, wherein the optical coating is disposed on the outer surface of the transparent envelope of the incandescent lamp.

16. A lighting fixture as defined in claim 13, wherein:
the lighting fixture further comprises a fixed transparent envelope surrounding the incandescent lamp; and
the optical coating is disposed on a surface of the fixed transparent envelope.

17. An incandescent lamp comprising:
a filament;
a transparent envelope defining an enclosed space in which the filament is located; and
an optical coating system disposed on a surface of the envelope, for transmitting light emitted by the filament in a prescribed visible wavelength band, while reflecting back toward the filament light emitted by the filament in other wavelength bands, whereupon a portion of such reflected light is absorbed by the filament;
wherein the optical coating system includes
a first coating including a plurality of dielectric layers having prescribed refractive indices and prescribed thicknesses, which are selected such that the first coating provides a prescribed transmittance/reflectance spectrum, and
a second coating including a transparent electrically conductive material having a thickness selected such that the second coating provides a prescribed transmittance/reflectance spectrum,
wherein the first and second coatings cooperate with each other and with the filament such that the lamp provides a higher luminous efficacy than would a corresponding lamp lacking such an optical coating system on its envelope.

18. An incandescent lamp as defined in claim 17, wherein the optical coating system is configured such that the lamp has a luminous efficacy of at least 40 lumens per watt.

19. An incandescent lamp as defined in claim 17, wherein the optical coating system is configured such that the lamp has a luminous efficacy of at least 60 lumens per watt.

20. An incandescent lamp as defined in claim 17, wherein the optical coating system is configured such that the lamp has a luminous efficacy of at least 80 lumens per watt.

21. An incandescent lamp as defined in claim 17, wherein the first and second coatings are contiguous with each other.

22. An incandescent lamp as defined in claim 21, wherein the optical coating system is located on the outer surface of the transparent envelope.

23. An incandescent lamp as defined in claim 21, wherein the second coating is located on the side of the first coating opposite the filament.

24. An incandescent lamp as defined in claim 21, wherein the second coating is located at an intermediate location within the plurality of layers of the first coating, closer to the side of the first coating opposite the filament than to the side of the first coating facing the filament.

25. An incandescent lamp as defined in claim 17, wherein:
the first coating includes a stack of alternating layers of high- and low-refractive index materials;
the high-refractive index layers all incorporate a material selected from the group consisting of TiO₂, Ta₂O₅, NbO₂, and mixtures thereof; and
the low-refractive index layers all incorporate a material selected from the group consisting of SiO₂, Al₂O₃, and mixtures thereof.

26. An incandescent lamp as defined in claim 17, wherein the second coating includes a transparent electrically conductive material selected from the group consisting of indium tin oxide, aluminum-doped zinc oxide, titanium-doped indium oxide, cadmium stannate, tin oxide-zinc stannate, gallium-doped zinc oxide, gold, silver, and mixtures thereof.

27. An incandescent lamp as defined in claim 17, wherein the first coating is configured such that it has an average reflectance greater than 90% across an infrared wavelength range of 740 to 2000 nm and such that it has an average transmittance less than 90% across a visible wavelength range of 400 to 700 nm.

28. An incandescent lamp as defined in claim 17, wherein the second coating is configured such that it has an average reflectance greater than 70% across an infrared wavelength range of 2000 to 4000 nm and such that it has an average absorptance less than 5% in the visible wavelength range of 400 to 700 nm.

29. An incandescent lamp as defined in claim 17, wherein the second coating is configured such that it has an average reflectance greater than 80% across an infrared wavelength range of 2000 to 4000 nm and such that it has an average absorptance less than 5% in the visible wavelength range of 400 to 700 nm.

30. An incandescent lamp as defined in claim 17, wherein the second coating is configured such that it has an average reflectance greater than 90% across an infrared wavelength range of 2000 to 4000 nm and such that it has an average absorptance less than 5% in the visible wavelength range of 400 to 700 nm.

31. An incandescent lamp as defined in claim 17, wherein the second coating is configured such that it has an average reflectance greater than 80% across an infrared wavelength range of 2000 to 4000 m and such that it has an average absorptance less than 10% in the visible wavelength range of 400 to 700 nm.

32. An incandescent lamp as defined in claim 17, wherein the second coating is configured such that it has an average reflectance greater than 90% across an infrared wavelength range of 2000 to 4000 nm and such that it has an average absorptance less than 10% in the visible wavelength range of 400 to 700 mm.

33. An incandescent lamp as defined in claim 17, wherein the second coating is configured such that it has an average reflectance greater than 90% across an infrared wavelength range of 2000 to 4000 nm and such that it has an average absorptance less than 20% in the visible wavelength range of 400 to 700 nm.

34. An incandescent lamp as defined in claim 17, and further comprising:
an electrical connector to which the transparent envelope is secured; and
a reflective coating disposed on a portion of the transparent envelope adjacent to the electrical connector, for reflecting visible and infrared light back toward the filament.

35. A lighting fixture comprising:
a housing;
a lamp socket carried by the housing; and
an incandescent lamp comprising
an electrical connector configured to be removably secured to the lamp socket,
a filament,
a transparent envelope secured to the electrical connector and defining an enclosed space in which the filament is located, and
an optical coating system disposed on a surface of the envelope, for transmitting light emitted by the lamp filament in a prescribed visible wavelength band, while reflecting back toward the filament light emitted by the filament in other wavelength bands, whereupon a portion of such reflected light is absorbed by the filament, wherein the optical coating system includes
a first coating including a plurality of dielectric layers having prescribed refractive indices and prescribed thicknesses, which are selected such that the first coating provides a prescribed transmittance/reflectance spectrum, and
a second coating including a transparent electrically conductive material having a thickness selected such that the second coating provides a prescribed transmittance/reflectance spectrum,
wherein the first and second coatings cooperate with each other
and with the filament such that the lamp provides a higher luminous efficacy than would a corresponding lamp lacking such an optical coating system on its envelope.

36. A lighting fixture comprising:
a housing;
a lamp socket carried by the housing; and
an incandescent lamp comprising
an electrical connector configured to be removably secured to the lamp socket,
a filament, and
a transparent envelope secured to the electrical connector and defining an enclosed space in which the filament is located,
wherein the fixture further comprises an optical coating system for transmitting light emitted by the filament in a prescribed visible wavelength band, while reflecting back toward the filament light emitted by the filament in other wavelength bands, whereupon a portion of such reflected light is absorbed by the filament;
and wherein the optical coating system includes
a first coating including a plurality of dielectric layers having prescribed refractive indices and prescribed thicknesses, which are selected such that the first coating provides a prescribed first transmission/reflection spectrum, and
a second coating including a transparent electrically conductive material having a thickness selected such that the second coating provides a prescribed second transmission/reflection spectrum,
wherein the first and second coatings cooperate with each other and with the filament such that the lighting fixture provides a higher luminous efficacy than would a corresponding lighting fixture lacking such an optical coating system.

37. A lighting fixture as defined in claim 36, wherein the optical coating system is disposed on a surface of the transparent envelope of the incandescent lamp.

38. A lighting fixture as defined in claim 37, wherein the optical coating system is disposed on the outer surface of the transparent envelope of the incandescent lamp.

39. A lighting fixture as defined in claim 36, wherein:
the lighting fixture further comprises a fixed transparent envelope surrounding the incandescent lamp; and
the optical coating is disposed on a surface of the fixed transparent envelope.

40. An incandescent lamp as defined in claim 8, wherein:
the optical coating further includes an IR-emissive coating located on the side of the one or more transparent electrically conductive layers opposite the filament; and
the IR-emissive coating has an average outer IR emissivity greater than that of a corresponding incandescent lamp lacking such an IR-emissive coating.

41. An incandescent lamp as defined in claim 40, wherein the optical coating further includes an oxygen diffusion barrier located between the one or more transparent electrically conductive layers and the IR-emissive coating.

42. An incandescent lamp as defined in claim 8, wherein:
the optical coating further includes an IR-emissive coating located on the side of the one or more transparent electrically conductive layers opposite the filament; and
the IR-emissive coating has a peak emissivity at a wavelength corresponding to the peak emission wavelength of the lamp envelope when the lamp is operating at its maximum power level.

43. An incandescent lamp as defined in claim 42, wherein:
the IR-emissive coating includes indium tin oxide; and
the IR-emissive coating has a plasma frequency corresponding to the peak emission frequency of the lamp envelope when the lamp is operating at its maximum power level.

44. An incandescent lamp as defined in claim 23, wherein:
the optical coating system further includes an IR-emissive coating located on the side of the second coating opposite the filament; and
the IR-emissive coating has an average outer IR emissivity greater than that of a corresponding incandescent lamp lacking such an IR-emissive coating.

45. An incandescent lamp as defined in claim 44, wherein the optical coating system further includes an oxygen diffusion barrier located between the second coating and the IR-emissive coating.

46. An incandescent lamp as defined in claim 23, wherein:
the optical coating system further includes an IR-emissive coating located on the side of the second coating opposite the filament; and
the IR-emissive coating has a peak emissivity at a wavelength corresponding to the peak emission wavelength of the lamp envelope when the lamp is operating at its maximum power level.

47. An incandescent lamp as defined in claim 46, wherein:
the optical coating system includes indium tin oxide; and
the IR-emissive coating has a plasma frequency corresponding to the peak emission frequency of the lamp envelope when the lamp is operating at its maximum power level.
